(19) United States
(12) Patent Application Publication
(10) Pub. No.: US 2019/0055464 A1
(43) Pub. Date: Feb. 21, 2019

(54) PROPPANTS COATED WITH A RESIN CONTAINING A CLAY

(71) Applicant: Georgia-Pacific Chemicals LLC, Atlanta, GA (US)

(72) Inventor: Richard A. Rediger, Conyers, GA (US)

(73) Assignee: Georgia-Pacific Chemicals LLC, Atlanta, GA (US)

(21) Appl. No.: 15/764,093

(22) PCT Filed: Sep. 27, 2016
(86) PCT No.: PCT/US2016/053914

§ 371 Date: Mar. 28, 2018

Related U.S. Application Data
(60) Provisional application No. 62/234,380, filed on Sep. 29, 2015.

(51) Int. Cl. C09K 8/80

(52) U.S. Cl. CPC C09K 8/805

(57) ABSTRACT

A plurality of proppants can include a plurality of particles and a cured composite resin, a curable composite resin, or a mixture of a cured composite resin and a curable composite resin disposed on each particle of the plurality of particles. The cured composite resin, prior to being cured, and the curable composite resin can each include a phenol-formaldehyde resin and an aluminosilicate clay, e.g., halloysite. The aluminosilicate clay can include a plurality of hollow tubular structures that can have an average exterior diameter of about 20 nm to about 200 nm and an average length of about 0.25 μm to about 10 μm.

### CROSS-REFERENCE TO RELATED APPLICATION

This is a National Stage application under 35 U.S.C. § 371 of PCT/US2016/053914, filed on Sep. 27, 2016, and published as WO 2017/058762, which claims priority to U.S. Provisional Patent Application No. 62/234,380, filed on Sep. 29, 2015, which are both incorporated by reference herein.

### BACKGROUND

### Field

Embodiments described generally relate to proppants and methods for making and using same. More particularly, such embodiments relate to proppants coated with a resin containing a clay and methods for making and using same.

### Description of the Related Art

The production of oil, natural gas, and other fluids from a subterranean formation can be enhanced by hydraulic fracturing. In general, hydraulic fracturing involves the injection of a fracturing fluid through a well bore and against the face of the subterranean formation to initiate new fractures and/or extend existing fractures in the subterranean formation. The fracturing fluid must be injected at a pressure and a flow rate great enough to overcome the overburden pressure, as well as to drive the fracturing of the subterranean formation.

The fracturing fluid usually contains proppant particles, such as sand or gravel, which is carried into the fractures. The proppant particles become lodged in the fractures where the particles minimize or eliminate fracture reduction or closure upon reduced downhole pressures due to the removal of downhole fluids and/or a cessation in the introduction of the fracturing fluid thereto. The proppant filled fractures provide permeable channels through which the downhole fluids flow into the well bore and thereafter are withdrawn for production.

The high closure stresses applied to the proppant particles lodged in a fracture can fragment and disintegrate the proppant when the dry crush strength of the proppant is too low for the particular environment of the fracture. For example, a closure pressure of about 34.5 MPa (about 5,000 psi) or greater can disintegrate frac sand traditionally used as a proppant. The resulting fines from the disintegrated proppant can migrate and plug the interstitial flow passages in the remaining proppant filled fractures. These migratory fines can drastically reduce the permeability of the propped fractures and therefore reduce or cease fluid production from such clogged fractures.

There is a need, therefore, for improved proppants that have a dry crush strength greater than traditional proppants and methods for making and using same.

### SUMMARY

Proppants and methods for making and using same are provided. In some examples, a plurality of proppants can include a plurality of particles and a cured composite resin disposed on each particle of the plurality of particles. The cured composite resin, prior to being cured, can include a phenol-formaldehyde resin and an aluminosilicate clay. The aluminosilicate clay can include a plurality of hollow tubular structures having an average exterior diameter of about 20 nm to about 200 nm and an average length of about 0.25 μm to about 10 μm.

In other examples, a plurality of proppants can include a plurality of particles and a cured composite resin disposed on each particle of the plurality of particles. The cured composite resin, prior to being cured, can include a phenol-formaldehyde resin and halloysite. The cured composite resin, prior to being cured, can include the halloysite in an amount of greater than 25 wt % to about 70 wt %, based on a solids weight of the phenol-formaldehyde resin. The plurality of proppants can have a dry crush strength of about 0.5 wt % to less than 10 wt % at a pressure of about 82.7 MPa.

In other examples, a plurality of proppants can include a plurality of particles and a cured composite resin disposed on each particle of the plurality of particles. The plurality of particles can include sand. Each particle of the plurality of particles can be completely covered by a continuous layer of the cured composite resin. The cured composite resin, prior to being cured, can include a phenol-formaldehyde novolac resin, halloysite, and a cross-linker. The plurality of proppants can have an average particle size of about 180 μm to about 2 mm. The plurality of proppants can have dry crush strength of about 0.5 wt % to less than 10 wt % at a pressure of about 82.7 MPa.

### DETAILED DESCRIPTION

One or more resins, e.g., a phenol-formaldehyde resins, and one or more clays, e.g., an aluminosilicate clay, one can be mixed, blended, or otherwise combined with one another to produce a composite resin. The clay can be or include one or more aluminosilicate clays, such as halloysite, that can have a hollow tubular structure. One or more particles can be at least partially coated or completely coated with the composite resin. The composite resin can be cured to produce a proppant. In some examples, one or more particles can be at least partially coated or completely coated with the composite resin and one or more cross-linkers. The composite resin and the cross-linker can be reacted to produce a cured composite resin at least partially covering or completely covering the particles to produce a proppant. In some examples, a plurality of particles can be at least partially coated or completely coated with the composite resin and one or more cross-linkers, which can be reacted to produce a cured composite resin at least partially covering or completely covering the particles to produce a plurality of proppants. It should be noted that the plurality of particles and the plurality of proppants can be or include two or more particles and two or more proppants, respectively. For example, the plurality of particles and the plurality of proppants can include from two to thousands, hundreds of thousands, millions, billions, or more particles and proppants, respectively.

It has been surprisingly and unexpectedly discovered that the proppants can have a dry crush strength of less than 10 wt % at a pressure of about 82.7 MPa (about 12,000 psi) and/or about 5 wt % or less at a pressure of about 55.2 MPa (about 8,000 psi). For example, the proppants can have a dry crush strength of about 0.5 wt % to less than 10 wt % at a pressure of about 82.7 MPa (about 12,000 psi) and/or about 0.1 wt % to about 5 wt % at a pressure of about 55.2 MPa (about 8,000 psi). The increased dry crush strength of the plurality of proppants coated with the cured resin containing the aluminosilicate clay, e.g., halloysite, was unexpected because the addition of conventional clays (e.g., kaolinite and/or montmorillonite) generally results in a reduction of the dry crush strength. The conventional clays generally have a flat or sheet structure or a spherical structure, whereas the aluminosilicate clays generally have a hollow tubular structure. Without wishing to be bound by theory, it is believed that the aluminosilicate clays having hollow tubular structures can deform under an applied pressure to a greater degree than conventional clays that have the flat, sheet, or a spherical structure. It is also believed that the hollow tubular structures of the aluminosilicate clay attributes, at least in part, to the surprisingly and unexpectedly high dry crush strength of the plurality of proppants. Therefore, it is believed that the particles coated with the cured resin containing halloysite and/or other aluminosilicate clay having hollow tubular structures can absorb more applied pressure over proppants composed of the same particles and coated with the same resin, but containing conventional clay since the hollow tubular structures can deform under such applied pressure more so than clay with a flat, sheet, or spherical structure.

Measurement of the dry crush strength can be based on the Proppant Crush Resistance Test Procedure under ISO 13503-2:2011, modified as follows. The ISO 13503-2:2011 test specifies a loading of 1.95 g/cm² for 20/40 sand having a bulk density of 1.60 g/cm³, which corresponds to a volume per area of 1.95 g/cm²/1.60 g/cm³ or 1.22 cm³/cm² for a cell having a piston length of 88.9 mm and a piston diameter of 50.8 mm. Accordingly, the volume specified in the ISO 13503-2:2011 test is given by 1.22 cm³/cm²×3.14×(5.08 cm/2)² or 24.7 cm³. With the density of 20/40 at 1.60 g/cm³ the weight of sample required in the ISO 13503-2:2011 test is 24.7×1.6=39.5 g. The dry crush strength values discussed and described herein can be measured with a stainless steel cylinder having upper and lower movable stainless pistons. The body of the cylinder can be about 7.63 cm in length and can include a removable bottom piston which extends about 1.30 cm into the bottom of the cylinder that can provide the base. The removable upper piston can be about 7.75 cm in length. The internal diameter of the pistons can be about 2.87 cm, which can provide a surface area of about 6.44 cm². The volume required to provide a loading of about 1.95 g/cm² can be calculated as follows: 1.22 cm³/cm²×3.14×(2.87 cm/2)² or 7.89 cm³. With the bulk density of 20/40 sand at 1.60 g/cm³ the weight of the sample can be calculated as follows: 7.89 cm³×1.60 g/cm³ or 12.6 g of sample. The ISO 13503-2:2011 test can also be modified by manually applying the pressure instead of constantly applying the pressure and holding the applied pressure for 30 seconds instead of two minutes. The dry crush strength values of the plurality of proppants discussed and described herein can also be measured according to the Proppant Crush Resistance Test Procedure under ISO 13503-2:2011 without any modification to the test procedure.

The composite resins can be made or otherwise produced by a variety of processes. As mentioned above, the composite resin can include one or more resins and one or more clays. Illustrative resins can include, but are not limited to, one or more aldehyde-based resins, one or more urethanes, one or more phenolic modified urethanes, one or more resin coatings based on Maillard chemistry, or any mixture thereof. Illustrative aldehyde-based resins can be or include, but are not limited to, one or more urea-formaldehyde (“UF”) resins, one or more phenol-formaldehyde (“PF”) resins, one or more melamine-formaldehyde (“MF”) resins, one or more resorcinol-formaldehyde (“RF”) resins or any mixture thereof. In some examples, the aldehyde-based resin can be or include combinations of amino-aldehyde copolymers. For example, the resin can be or include, but is not limited to, one or more melamine-urea-formaldehyde (“MUF”) resins, one or more phenol-urea-formaldehyde (“PUF”) resins, one or more phenol-melamine-formaldehyde (“PMF”) resins, one or more phenol-resorcinol-formaldehyde (“PRF”) resins, polymers thereof, or derivatives thereof. In some examples, the aldehyde-based resin can be or include a co-polymer produced from styrene-acrylic acid, acrylic acid, maleic acid, or any mixture thereof. For example, the aldehyde-based resin can be or include a combination of an amino-aldehyde copolymer and/or a phenol-aldehyde copolymer and a polyacrylic acid, for example, urea-formaldehyde-polyacrylic acid, melamine-formaldehyde-polyacrylic acid, phenol-formaldehyde-polyacrylic acid, or any mixture thereof. In some examples, the resin can be or include one or more phenol-formaldehyde resins. In at least one example, the resin can be a phenol-formaldehyde resin. Illustrative resin coatings based on Maillard chemistry can include those discussed and described in U.S. Pat. No. 9,045,678 and U.S. Patent Application Publication Nos. 2011/0278003 and 2015/0275072.

For simplicity and ease of description, the resin can be discussed and described as being a phenol-formaldehyde resin. It should be understood, however, that the resin can be or include other resins such as the one or more urethanes, the one or more phenolic modified urethanes, the one or more resin coatings based on Maillard chemistry, and/or other aldehyde-based resins mentioned above. The phenol-formaldehyde resin, when added, mixed, or otherwise combined with the clay to produce the composite resin, can be in a solid state, a molten state, or a liquid state (e.g., liquids, solutions, suspensions, emulsions, dispersions, flocculations, or in one or multiple phases). The clay, when added, mixed, or otherwise combined with the phenol-formaldehyde resin to produce the composite resin, can be in a solid state (e.g., particulate, powder, block, or paste) or a liquid state (e.g., suspensions, emulsions, dispersions, flocculations, solutions, or in one or multiple phases). In some examples, the clay in a solid state can be added to the phenol-formaldehyde resin in a molten state to produce a dispersion of the clay and the molten phenol-formaldehyde resin. The dispersion, i.e., the composite resin, can be directly used as a flowable material to at least partially coat particles or can be cooled, solidified, and used at a later time. In other examples, the clay in a solid state can be added to the phenol-formaldehyde resin in a solid state and the solid mixture can be heated to produce a molten dispersion of the composite resin. In other examples, the clay can be dispersed in a liquid medium (e.g., water and/or one or more other solvents) can be added to the phenol-formaldehyde resin in any state to produce the composite resin.

In one or more examples, the clay can be added, mixed, or otherwise combined with the phenol-formaldehyde resin that is in a molten state. For example, the clay can be added to the molten phenol-formaldehyde resin and the mixture can be agitated to produce the molten composite resin that can be cooled to produce the solidified composite resin. In other examples, the clay can be added, mixed, or otherwise combined with a reaction mixture that includes the phenol-formaldehyde resin. For example, the clay can be added to a reaction mixture of phenol and formaldehyde that has formed the phenol-formaldehyde resin. The clay can be further mixed with the phenol-formaldehyde resin to produce the composite resin.

In one example, one or more solid phenol-formaldehyde resins (e.g., P-F resins having a solid state) can be used as starting materials for making the composite resin. The one or more solid phenol-formaldehyde resins can be heated to produce a molten phenol-formaldehyde resin. The solid phenol-formaldehyde resin can be heated to a temperature of about 100° C., about 105° C., about 110° C., or about 115° C. to about 120° C., about 125° C., about 130° C., about 135° C., about 138° C., about 140° C., about 142° C., about 145° C., about 148° C., about 150° C., about 155° C., about 160° C., about 170° C., about 180° C., about 190° C., about 200° C., or greater to produce the molten phenol-formaldehyde resin. For example, the phenol-formaldehyde resin can be heated to a temperature of about 100° C. to about 200° C., about 110° C. to about 200° C., about 105° C. to about 180° C., about 110° C. to about 180° C., about 110° C. to about 170° C., about 110° C. to about 160° C., about 110° C. to about 150° C., about 110° C. to about 145° C., about 110° C. to about 140° C., about 120° C. to about 180° C., about 120° C. to about 170° C., about 120° C. to about 160° C., about 120° C. to about 150° C., about 120° C. to about 145° C., about 120° C. to about 140° C., about 130° C. to about 180° C., about 130° C. to about 170° C., about 130° C. to about 160° C., about 130° C. to about 150° C., about 130° C. to about 145° C., about 130° C. to about 140° C., about 140° C. to about 160° C., about 140° C. to about 150° C., or about 140° C. to about 145° C. to produce the molten phenol-formaldehyde resin.

The phenol-formaldehyde resin can be heated for about 1 min, about 2 min, about 3 min, about 5 min, or about 8 min to about 10 min, about 15 min, about 20 min, about 30 min, about 40 min, about 50 min, about 1 hr, about 1.5 hr, about 2 hr, or greater to produce the molten phenol-formaldehyde resin. For example, the solid phenol-formaldehyde resin can be heated for about 1 min to about 2 hr, about 2 min to about 1 hr, about 5 min to about 30 min, about 5 min to about 20 min, about 5 min to about 15 min, about 10 min to about 30 min, about 10 min to about 20 min, or about 10 min to about 15 min to produce the molten phenol-formaldehyde resin.

The phenol-formaldehyde resin can be maintained under an inert atmosphere, such as an atmosphere containing one or more inert gases and/or under vacuum to produce the molten phenol-formaldehyde resin. Illustrative inert gases can include, but are not limited to, nitrogen, argon, helium, any mixture thereof, or other inert gas sufficiently non-reactive with the solid or molten phenol-formaldehyde resins can be flowed over and/or through the solid phenol-formaldehyde resin when heated to the molten state. In one specific example, the solid phenol-formaldehyde resin can be maintained under a nitrogen atmosphere, e.g., at least 99 mol % nitrogen gas, and heated to a temperature of about 60° C. to about 100° C. or about 80° C. to about 85° C. for about 2 hr to about 3 hr to produce the molten phenol-formaldehyde resin.

The one or more clays and the molten phenol-formaldehyde resin can be mixed, blended, or otherwise combined to produce a molten mixture. For example, the clay can be added to the molten phenol-formaldehyde resin and agitated to produce the molten mixture, such as a molten resin clay dispersion. Thereafter, the molten mixture can be heated for a period of time to produce the composite resin. Subsequently, the composite resin can be cooled to produce a solidified composite resin.

The molten mixture can be heated to a temperature of about 100° C., about 105° C., about 110° C., or about 115° C. to about 120° C., about 125° C., about 130° C., about 135° C., about 137° C., about 139° C., about 140° C., about 150° C., about 160° C., about 170° C., about 180° C., about 190° C., about 200° C., or greater to produce the composite resin. For example, the molten mixture can be heated to a temperature of about 100° C. to about 220° C., about 110° C. to about 200° C., about 105° C. to about 180° C., about 110° C. to about 180° C., about 110° C. to about 170° C., about 110° C. to about 160° C., about 110° C. to about 150° C., about 110° C. to about 145° C., about 110° C. to about 140° C., about 120° C. to about 180° C., about 120° C. to about 170° C., about 120° C. to about 160° C., about 120° C. to about 150° C., about 120° C. to about 145° C., about 120° C. to about 140° C., about 130° C. to about 180° C., about 130° C. to about 170° C., about 130° C. to about 160° C., about 130° C. to about 150° C., about 130° C. to about 145° C., about 130° C. to about 140° C., about 135° C. to about 140° C., or about 135° C. to about 145° C. to produce the composite resin.

The molten mixture can be heated for about 1 min, about 5 min, about 10 min, or about 15 min to about 20 min, about 30 min, about 45 min, about 1 hr, about 1.5 hr, about 2 hr, or about 3 hr to produce the composite resin. For example, the molten mixture can be heated for about 1 min to about 3 hr, about 5 min to about 2 hr, about 5 min to about 1 hr, about 10 min to about 1 hr, about 10 min to about 45 min, about 10 min to about 30 min, about 20 min to about 1 hr, about 20 min to about 45 min, or about 20 min to about 30 min to produce the composite resin.

The molten mixture that can be or include the composite resin can be cooled to a temperature sufficiently low enough to produce the solidified composite resin, such as a temperature of less than 50° C. or an ambient temperature (e.g., about 23° C.). The molten mixture can be cooled to about 20° C., about 22° C., about 23° C., about 24° C., or about 25° C. to about 26° C., about 28° C., about 30° C., about 35° C., about 40° C., about 45° C., or about 50° C. to produce the solidified composite resin. In some examples, The molten mixture can be cooled to about 20° C., about 22° C., about 23° C., about 24° C., or about 25° C. to less than 28° C., less than 30° C., less than 35° C., less than 40° C., less than 45° C., or less than 50° C. to produce the solidified composite resin. For example, the molten mixture can be cooled to about 20° C. to about 30° C., about 22° C. to about 27° C., or about 23° C. to about 25° C. to produce the solidified composite resin.

In some examples, the composite resin can include the clay in an amount of greater than 25 wt %, greater than 26 wt %, greater than 27 wt %, greater than 28 wt %, greater than 29 wt %, or greater than 30 wt % to about 32 wt %, about 34 wt %, about 35 wt %, about 38 wt %, about 40 wt %, about 45 wt %, about 50 wt %, about 55 wt %, about 60 wt %, about 65 wt %, about 70 wt %, about 75 wt %, or about 80 wt %, based on the solids weight of the phenol-formaldehyde resin. In other examples, the composite resin can include the clay in an amount of greater than 25 wt %, greater than 27 wt %, greater than 30 wt %, greater than 32 wt %, greater than 34 wt %, greater than 35 wt %, greater than 37 wt %, greater than 40 wt %, greater than 42 wt %, greater than 45 wt %, or greater than 47 wt % to about 50 wt %, about 55 wt %, about 60 wt %, about 65 wt %, about 70 wt %, about 75 wt %, or about 80 wt %, based on the solids weight of the phenol-formaldehyde resin. For example, the composite resin can include the clay in an amount of greater than 25 wt % to about 50 wt %, greater than 28 wt % to about 50 wt %, greater than 30 wt % to about 50 wt %, greater than 35 wt % to about 50 wt %, greater than 40 wt % to about 50 wt %, greater than 45 wt % to about 50 wt %, greater than 25 wt % to about 40 wt %, greater than 28 wt % to about 40 wt %, greater than 30 wt % to about 40 wt %, greater than 35 wt % to about 40 wt %, greater than 25 wt % to about 70 wt %, greater than 28 wt % to about 70 wt %, greater than 30 wt % to about 70 wt %, greater than 35 wt % to about 70 wt %, greater than 40 wt % to about 70 wt %, greater than 45 wt % to about 70 wt %, greater than 50 wt % to about 70 wt %, greater than 55 wt % to about 70 wt %, greater than 60 wt % to about 70 wt %, greater than 65 wt % to about 70 wt %, greater than 25 wt % to about 35 wt %, greater than 28 wt % to about 35 wt %, or greater than 30 wt % to about 35 wt %, based on the solids weight of the phenol-formaldehyde resin.

In other examples, the composite resin can include the clay in an amount of about 5 wt %, about 10 wt %, about 15 wt %, about 18 wt %, about 20 wt %, about 22 wt %, about 23 wt %, about 24 wt %, or about 25 wt % to about 26 wt %, about 28 wt %, about 30 wt %, about 32 wt %, about 33 wt %, about 34 wt %, about 35 wt %, about 36 wt %, about 38 wt %, about 40 wt %, about 45 wt %, about 50 wt %, about 55 wt %, about 60 wt %, about 65 wt %, about 70 wt %, about 75 wt %, about 80 wt %, or greater, based on the solids weight of the phenol-formaldehyde resin. For example, the composite resin can include the clay in an amount of about 5 wt % to about 70 wt %, about 5 wt % to about 60 wt %, about 5 wt % to about 50 wt %, about 10 wt % to about 50 wt %, about 15 wt % to about 50 wt %, about 20 wt % to about 50 wt %, about 22 wt % to about 50 wt %, about 25 wt % to about 50 wt %, about 28 wt % to about 50 wt %, about 30 wt % to about 50 wt %, about 35 wt % to about 50 wt %, about 40 wt % to about 50 wt %, about 45 wt % to about 50 wt %, about 10 wt % to about 40 wt %, about 15 wt % to about 40 wt %, about 20 wt % to about 40 wt %, about 22 wt % to about 40 wt %, about 25 wt % to about 40 wt %, about 28 wt % to about 40 wt %, about 30 wt % to about 40 wt %, about 35 wt % to about 40 wt %, about 10 wt % to about 70 wt %, about 15 wt % to about 70 wt %, about 20 wt % to about 70 wt %, about 22 wt % to about 70 wt %, about 25 wt % to about 70 wt %, about 28 wt % to about 70 wt %, about 30 wt % to about 70 wt %, about 35 wt % to about 70 wt %, about 40 wt % to about 70 wt %, about 45 wt % to about 70 wt %, about 50 wt % to about 70 wt %, about 55 wt % to about 70 wt %, about 60 wt % to about 70 wt %, about 65 wt % to about 70 wt %, about 10 wt % to about 35 wt %, about 15 wt % to about 35 wt %, about 20 wt % to about 35 wt %, about 22 wt % to about 35 wt %, about 25 wt % to about 35 wt %, about 28 wt % to about 35 wt %, or about 30 wt % to about 35 wt %, based on the solids weight of the phenol-formaldehyde resin.

The solids or non-volatiles content of any of the compounds, polymers, or resins discussed and described herein, such as the cured composite resin or the phenol-formaldehyde resin, can be measured by determining the weight loss upon heating a small sample, e.g., about 5 grams to about 8 grams of the sample, to a suitable temperature, e.g., 105° C., for a time sufficient to remove the liquid medium therefrom. By measuring the weight of the sample before and after heating, the amount of the solids or non-volatiles in the sample can be directly calculated or otherwise estimated. It should be noted that the temperature used to remove the liquid medium can depend, at least in part, on the particular liquid medium(s) present in the sample, e.g., the cured composite resin or the phenol-formaldehyde resin.

The clay can be or include one or more aluminosilicate clays, such as one or more kaolin clays. The aluminosilicate clay can have or be in the form of hollow tubular structures. The hollow tubular structures can have and average exterior diameter and/or an average interior diameter in the nanometer range and typically can have an average length in the micrometer range.

In some examples, aluminosilicate clays having a hollow tubular structure can have an average exterior diameter of about 20 nm, about 25 nm, about 30 nm, about 35 nm, about 40 nm, about 45 nm, or about 50 nm to about 55 nm, about 60 nm, about 65 nm, about 70 nm, about 75 nm, about 80 nm, about 85 nm, about 90 nm, about 95 nm, about 100 nm, about 120 nm, about 150 nm, about 180 nm, about 200 nm, about 250 nm, or greater. For example, the hollow tubular structures of the aluminosilicate clays can have an average exterior diameter of about 20 nm to about 250 nm, about 20 nm to about 200 nm, about 20 nm to about 100 nm, about 20 nm to about 80 nm, about 20 nm to about 70 nm, about 20 nm to about 60 nm, about 20 nm to about 50 nm, about 20 nm to about 40 nm, about 20 nm to about 30 nm, about 30 nm to about 200 nm, about 30 nm to about 150 nm, about 30 nm to about 100 nm, about 30 nm to about 90 nm, about 30 nm to about 80 nm, about 30 nm to about 70 nm, about 30 nm to about 60 nm, about 30 nm to about 50 nm, about 30 nm to about 40 nm, about 40 nm to about 200 nm, about 40 nm to about 150 nm, about 40 nm to about 100 nm, about 40 nm to about 90 nm, about 40 nm to about 80 nm, about 40 nm to about 70 nm, about 40 nm to about 60 nm, about 40 nm to about 50 nm, about 50 nm to about 200 nm, about 50 nm to about 150 nm, about 50 nm to about 100 nm, about 50 nm to about 90 nm, about 50 nm to about 80 nm, about 50 nm to about 70 nm, or about 50 nm to about 60 nm.

In some examples, the aluminosilicate clays that can have a hollow tubular structure can have an average interior diameter of about 5 nm, about 8 nm, about 10 nm, about 12 nm, about 15 nm, or about 18 nm to about 20 nm, about 22 nm, about 25 nm, about 28 nm, about 30 nm, about 35 nm, about 40 nm, about 50 nm, or greater. For example, the hollow tubular structures of the aluminosilicate clays can have an average interior diameter of about 5 nm to about 50 nm, about 5 nm to about 40 nm, about 5 nm to about 30 nm, about 5 nm to about 25 nm, about 5 nm to about 20 nm, about 5 nm to about 15 nm, about 5 nm to about 10 nm, about 10 nm to about 50 nm, about 10 nm to about 40 nm, about 10 nm to about 30 nm, about 10 nm to about 25 nm, about 10 nm to about 20 nm, about 10 nm to about 15 nm, about 15 nm to about 50 nm, about 15 nm to about 40 nm, about 15 nm to about 30 nm, about 15 nm to about 25 nm, about 15 nm to about 20 nm, about 20 nm to about 50 nm, about 20 nm to about 40 nm, about 20 nm to about 30 nm, or about 20 nm to about 25 nm.

In some examples, the aluminosilicate clays can have a hollow tubular structure and can have an average length of about 0.25 μm, about 0.3 μm, about 0.35 μm, about 0.4 μm, about 0.45 μm, about 0.5 μm, about 0.6 μm, about 0.7 μm, about 0.8 μm, about 0.9 μm, or about 1 μm to about 1.1 μm, about 1.2 μm, about 1.4 μm, about 1.5 μm, about 1.8 μm, about 2 μm, about 2.1 μm, about 2.2 μm, about 2.4 μm, about 2.5 μm, about 2.8 μm, about 3 μm, about 3.2 μm, about 3.4 μm, about 3.5 μm, about 3.8 μm, about 4 μm, about 4.5 μm, about 5 μm, about 6 μm, about 7 μm, about 8 μm, about 9 μm, about 10 μm, or greater. For example, the hollow tubular structures of the aluminosilicate clays can have an average length of about 0.25 μm to about 10 μm, about 0.4 μm to about 8 μm, about 0.4 μm to about 6 μm, about 0.4 μm to about 5 μm, about 0.4 μm to about 4 μm, about 0.4 μm to about 2 μm, about 0.4 μm to about 1 μm, about 0.5 μm to about 8 μm, about 0.5 μm to about 6 μm, about 0.5 μm to about μm, about 0.5 μm to about 4 μm, about 0.5 μm to about 3 μm, about 0.5 μm to about 2 μm, about 0.5 μm to about 1 μm, about 0.8 μm to about 8 μm, about 0.8 μm to about 6 μm, about 0.8 μm to about 5 μm, about 0.8 μm to about 4 μm, about 0.8 μm to about 3 μm, about 0.8 μm to about 2 μm, about 0.8 μm to about 1 μm, about 1 μm to about 8 μm, about 1 μm to about 6 μm, about 1 μm to about 5 μm, about 1 μm to about 4 μm, about 1 μm to about 3 μm, about 1 μm to about 2 μm, about 1.5 μm to about 8 μm, about 1.5 μm to about 6 μm, about 1.5 μm to about 5 μm, about 1.5 μm to about 4 μm, about 1.5 μm to about 3 μm, about 1.5 μm to about 2 μm, about 2 μm to about 8 μm, about 2 μm to about 6 μm, about 2 μm to about 5 μm, about 2 μm to about 4 μm, or about 2 μm to about 3 μm.

In some examples, the hollow tubular structures of the aluminosilicate clays can have an average exterior diameter of about 20 nm to about 200 nm, an average internal diameter of about 10 nm to about 50 nm, and an average length of about 0.25 μm to about 10 μm. In other examples, the hollow tubular structures of the aluminosilicate clays can have an average exterior diameter of about 30 nm to about 100 nm, an average interior diameter of about 10 nm to about 40 nm, and an average length of about 0.4 μm to about 8 μm. In other examples, the hollow tubular structures of the aluminosilicate clays can have an average exterior diameter of about 50 nm to about 70 nm, an average internal diameter of about 15 nm to about 30 nm, and an average length of about 0.5 μm to about 3 μm. In other examples, the hollow tubular structures of the aluminosilicate clays can have an average exterior diameter of about 30 nm to about 70 nm, an average internal diameter of about 15 nm to about 25 nm, and an average length of about 1 μm to about 3 μm.

Illustrative aluminosilicate clays can be or include, but are not limited to, halloysite, one or more treated halloysite clays, one or more treated aluminosilicate clays, hydrates thereof, hydrous derivatives thereof, or any mixture thereof. For example, the aluminosilicate clay can be or include halloysite that has the empirical chemical formula of Al₂Si₂O₅(OH)₄ and/or hydrous aluminum silicate that has the chemical formula Al₂O₃.2SiO₂.2H₂O. The treated halloysite clay or other treated aluminosilicate clays can be or include one or more reaction products of the clay and one or more additives and/or one or more agents. The treated clays can have one or more surfaces modified by the one or more additives and/or the one or more agents. For example, at least a portion of the clay can have one or more chemically treated surfaces, such as an outer surface of the hollow tubular structures. The chemically treated surfaces can include the reaction product of the clay and one or more reducing agents, one or more oxidizing agents, one or more capping agents, or other products.

Illustrative additives and/or agents for treating aluminosilicate clays (e.g., halloysite) can be or include, but are not limited to, one or more of: silanes, organosilanes, aminosilanes, amines, organoamines, phosphines, organophosphines, boranes, organoboranes, solvents (e.g., water or organic solvents), complexes thereof, salts thereof, hydrates thereof, solvates thereof, or any mixture thereof. In some examples, the additives and/or agents can be or include, but are not limited to, one or more of: trimethyl stearyl ammonium, octadecylamine, dimethyl dialkyl amine or diethyl dialkyl amine (dialkyl can be C₁₄-C₁₈), complexes thereof, salts thereof, hydrates thereof, solvates thereof, or any mixture thereof. Illustrative aluminosilicate clays can be or include DRAGONITE® HP halloysite clay (equal to or greater than 95 wt % to less than 98.5 wt % of hydrous aluminum silicate and equal to or greater than 1.5 wt % to less than 5 wt % of quartz) and/or DRAGONITE® HP:KT purified halloysite clay (equal to or greater than 98.5 wt % to about 99.999 wt % of hydrous aluminum silicate and about 0.01 wt % to less than 1.5 wt % of quartz), both commercially available from Applied Minerals, Inc.

In some examples, the aluminosilicate clay can include halloysite and one or more impurities. Illustrative impurities can include, but are not limited to, one or more of: other type of clays, sands, rocks, minerals, salts, or any mixture thereof. Some specific illustrative impurities can include, but are not limited to, one or more of: silicon dioxide or quartz (SiO₂), aluminum oxide (Al₂O₃), goethite, limonite, alunite, rhyolite, carbonate rocks, igneous rocks, or any mixture thereof. The aluminosilicate clay can include one or more impurities in an amount of about 0.0001 wt %, about 0.001 wt %, about 0.005 wt %, about 0.01 wt %, about 0.03 wt %, or about 0.05 wt % to about 0.06 wt %, about 0.08 wt %, about 0.1 wt %, about 0.3 wt %, about 0.5 wt %, about 1 wt %, about 2 wt %, about 3 wt %, about 4 wt %, about 5 wt %, about 6 wt %, about 8 wt %, about 10 wt %, about 12 wt %, about 15 wt %, or greater, based on the total weight of the aluminosilicate clay. For example, the aluminosilicate clay can include one or more impurities in an amount of about 0.0001 wt % to about 15 wt %, about 0.001 wt % to about 15 wt %, about 0.001 wt % to about 12 wt %, about 0.001 wt % to about 10 wt %, about 0.001 wt % to about 8 wt %, about 0.001 wt % to about 5 wt %, about 0.001 wt % to about 3 wt %, about 0.001 wt % to about 2 wt %, about 0.001 wt % to about 1 wt %, about 0.001 wt % to about 0.5 wt %, about 0.001 wt % to about 0.1 wt %, about 0.001 wt % to about 0.01 wt %, about 0.01 wt % to about 15 wt %, about 0.01 wt % to about 12 wt %, about 0.01 wt % to about 10 wt %, about 0.01 wt % to about 8 wt %, about 0.01 wt % to about 5 wt %, about 0.01 wt % to about 3 wt %, about 0.01 wt % to about 2 wt %, about 0.01 wt % to about 1 wt %, about 0.01 wt % to about 0.5 wt %, about 0.01 wt % to about 0.1 wt %, about 0.1 wt % to about 15 wt %, about 0.1 wt % to about 12 wt %, about 0.1 wt % to about 10 wt %, about 0.1 wt % to about 8 wt %, about 0.1 wt % to about 5 wt %, about 0.1 wt % to about 3 wt %, about 0.1 wt % to about 2 wt %, about 0.1 wt % to about 1 wt %, or about 0.1 wt % to about 0.5 wt %, based on the total weight of the aluminosilicate clay.

In other examples, the aluminosilicate clay can include one or more impurities in an amount of about 0.0001 wt %, about 0.001 wt %, about 0.005 wt %, about 0.01 wt %, about 0.03 wt %, or about 0.05 wt % to less than 0.06 wt %, less than 0.08 wt %, less than 0.1 wt %, less than 0.3 wt %, less than 0.5 wt %, less than 1 wt %, less than 2 wt %, less than 3 wt %, less than 4 wt %, less than 5 wt %, less than 6 wt %, less than 8 wt %, less than 10 wt %, less than 12 wt %, less than 15 wt %, based on the total weight of the aluminosilicate clay. For example, the aluminosilicate clay can include one or more impurities in an amount of about 0.0001 wt % to less than 15 wt %, about 0.001 wt % to less than 15 wt %, about 0.001 wt % to less than 12 wt %, about 0.001 wt % to less than 10 wt %, about 0.001 wt % to less than 8 wt %, about 0.001 wt % to less than 5 wt %, about 0.001 wt % to less than 3 wt %, about 0.001 wt % to less than 2 wt %, about 0.001 wt % to less than 1 wt %, about 0.001 wt % to less than 0.5 wt %, about 0.001 wt % to less than 0.1 wt %, about 0.001 wt % to less than 0.01 wt %, about 0.01 wt % to less than 15 wt %, about 0.01 wt % to less than 12 wt %, about 0.01 wt % to less than 10 wt %, about 0.01 wt % to less than 8 wt %, about 0.01 wt % to less than 5 wt %, about 0.01 wt % to less than 3 wt %, about 0.01 wt % to less than 2 wt %, about 0.01 wt % to less than 1 wt %, about 0.01 wt % to less than 0.5 wt %, about 0.01 wt % to less than 0.1 wt %, about 0.1 wt % to less than 15 wt %, about 0.1 wt % to less than 12 wt %, about 0.1 wt % to less than 10 wt %, about 0.1 wt % to less than 8 wt %, about 0.1 wt % to less than 5 wt %, about 0.1 wt % to less than 3 wt %, about 0.1 wt % to less than 2 wt %, about 0.1 wt % to less than 1 wt %, or about 0.1 wt % to less than 0.5 wt %, based on the total weight of the aluminosilicate clay.

The aluminosilicate clay can include or be composed of halloysite in an amount of about 85 wt %, about 88 wt %, about 90 wt %, about 92 wt %, or about 95 wt % to about 96 wt %, about 97 wt %, about 98 wt %, about 99 wt %, about 99.5 wt %, about 99.9 wt %, about 99.95 wt %, about 99.99 wt %, or about 99.999 wt %, based on the total weight of the aluminosilicate clay. For example, the aluminosilicate clay can include or be composed of halloysite in an amount of about 85 wt % to about 99.999 wt %, about 85 wt % to about 99.99 wt %, about 88 wt % to about 99.99 wt %, about 90 wt % to about 99.99 wt %, about 95 wt % to about 99.99 wt %, about 96 wt % to about 99.99 wt %, about 97 wt % to about 99.99 wt %, about 98 wt % to about 99.99 wt %, about 99 wt % to about 99.99 wt %, about 99.5 wt % to about 99.99 wt %, about 99.9 wt % to about 99.99 wt %, about 85 wt % to about 99.9 wt %, about 88 wt % to about 99.9 wt %, about 90 wt % to about 99.9 wt %, about 95 wt % to about 99.9 wt %, about 96 wt % to about 99.9 wt %, about 97 wt % to about 99.9 wt %, about 98 wt % to about 99.9 wt %, about 99 wt % to about 99.9 wt %, about 99.5 wt % to about 99.9 wt %, about 85 wt % to about 99 wt %, about 88 wt % to about 99 wt %, about 90 wt % to about 99 wt %, about 95 wt % to about 99 wt %, about 96 wt % to about 99 wt %, about 97 wt % to about 99 wt %, or about 98 wt % to about 99 wt %, based on the total weight of the aluminosilicate clay.

In some examples, the aluminosilicate clay can include or be composed of halloysite in an amount of greater than 85 wt %, greater than 88 wt %, greater than 90 wt %, greater than 92 wt %, greater than 95 wt %, greater than 96 wt %, greater than 97 wt %, greater than 98 wt %, greater than 99 wt %, greater than 99.5 wt %, greater than 99.9 wt %, greater than 99.95 wt %, greater than 99.99 wt %, or greater than 99.999 wt %, based on the total weight of the aluminosilicate clay. For example, the aluminosilicate clay can include or be composed of halloysite in an amount of greater than 85 wt % to about 99.999 wt %, greater than 85 wt % to about 99.99 wt %, greater than 88 wt % to about 99.99 wt %, greater than 90 wt % to about 99.99 wt %, greater than 95 wt % to about 99.99 wt %, greater than 96 wt % to about 99.99 wt %, greater than 97 wt % to about 99.99 wt %, greater than 98 wt % to about 99.99 wt %, greater than 99 wt % to about 99.99 wt %, greater than 99.5 wt % to about 99.99 wt %, greater than 99.9 wt % to about 99.99 wt %, greater than 85 wt % to about 99.9 wt %, greater than 88 wt % to about 99.9 wt %, greater than 90 wt % to about 99.9 wt %, greater than 95 wt % to about 99.9 wt %, greater than 96 wt % to about 99.9 wt %, greater than 97 wt % to about 99.9 wt %, greater than 98 wt % to about 99.9 wt %, greater than 99 wt % to about 99.9 wt %, greater than 99.5 wt % to about 99.9 wt %, greater than 85 wt % to about 99 wt %, greater than 88 wt % to about 99 wt %, greater than 90 wt % to about 99 wt %, greater than 95 wt % to about 99 wt %, greater than 96 wt % to about 99 wt %, greater than 97 wt % to about 99 wt %, or greater than 98 wt % to about 99 wt %, based on the total weight of the aluminosilicate clay.

The phenol-formaldehyde resin can be produced by adding to a reactor containing phenol and an amount of formaldehyde sufficient to establish an initial formaldehyde to phenol (F:P) molar ratio of about 0.6:1 to about 5:1. In some examples, the phenol-formaldehyde resin can be a novolac resin and can have a F:P molar ratio of less than 1:1, less than 0.9:1, or less than 0.8:1. Phenolic novolac resins that have a molar deficiency of formaldehyde relative to phenol are generally thermoplastic materials that do not cure in the absence of a cross-linker. In one or more examples, the phenol-formaldehyde resins can be or include one or more phenol-formaldehyde novolac resins. In other examples, the phenol-formaldehyde resin can be a resole resin and can have a F:P molar ratio of about 1:1 or greater. Phenolic resole resins have an equal molar amount of formaldehyde to phenol or have a molar deficiency of phenol relative to formaldehyde. In some examples, the phenol-formaldehyde resins can have an F:P molar ratio of about 0.6:1 to about 1:1, about 0.6:1 to less than 1:1, about 0.6:1 to about 0.8:1, about 0.6:1 to less than 0.8:1, about 0.6:1 to about 0.9:1, about 0.6:1 to less than 0.9:1, about 0.6:1 to less than 0.95:1, or about 0.6:1 to less than 1:1. In other examples, the phenol-formaldehyde resins can have an F:P molar ratio of about 1:1 to about 2.65:1, about 1:1 to about 2.5:1, about 1:1 to about 2:1, about 1:1 to about 3:1, about 1:1 to about 4:1, about 1:1 to about 5:1, or about 1:1 to about 6:1.

As noted above, the resin include one or more aldehyde-based resins other than a phenol-formaldehyde resin, urethanes, phenolic modified urethanes, and/or reins based on Maillard chemistry. Such resins can include the one or more aldehyde-based resins, urethanes, phenolic modified urethanes, and/or resins based on Maillard chemistry with or without the phenol-formaldehyde resins. Therefore, the composite resins can be or include the one or more aluminosilicate clays and one or more aldehyde-based resins other than a phenol-formaldehyde resin. Alternatively, the composite resins can include the one or more aluminosilicate clays and one or more phenol-formaldehyde resins and/or one or more aldehyde-based resins other than a phenol-formaldehyde resin, urethanes, phenolic modified urethanes, and/or resins based on Maillard chemistry.

It should be noted that the above mentioned cured composite resins can also be disposed on the plurality of particles in a curable configuration or state as well. Suitable composite resins that can be in the curable configuration or state can be produced by controlling or adjusting the coating temperature and/or the time that the particles can be coated at the coating temperature. Accordingly, in some examples, the plurality of proppants can include a plurality of particles and a curable composite resin disposed on each particle of the plurality of particles. In some examples, the curable composite resin can include a phenol-formaldehyde resin and an aluminosilicate clay, and the aluminosilicate clay can include a plurality of hollow tubular structures having an average exterior diameter of about 20 nm to about 200 nm and an average length of about 0.25 μm to about 10 μm. In other examples, the curable composite resin can include a phenol-formaldehyde resin and halloysite, and the curable composite resin can include the halloysite in an amount of greater than 25 wt % to about 70 wt %, based on a solids weight of the phenol-formaldehyde resin. In other examples, the plurality of proppants, can include a plurality of sand particles and a curable composite resin disposed on each particle of the plurality of particles. Each particle of the plurality of particles can be completely covered by a continuous layer of the curable composite resin. The curable composite resin can include a phenol-formaldehyde novolac resin and halloysite and the plurality of proppants can have average particle size of about 180 μm to about 2 mm. In some examples, proppants that include the particle and a curable composite resin disposed thereon can be introduced to a downhole environment where the curable resin can be cured.

The composite resin, besides containing the clay and the resin, e.g., the phenol-formaldehyde resin, can also include one or more additives. Illustrative additives can be or include, but are not limited to, one or more dibasic esters, one or more waxes, one or more aminosilanes, one or more organic acids, one or more solvents, one or more pH adjusting agents, or any mixture thereof.

The composite resin can include one or more dibasic esters. The dibasic ester can be or include one or more compounds that have the chemical formula CH3O2C(CH2)nCO2CH3, where n can be 1, 2, 3, 4, or 5. For example, the dibasic ester can be or include dibasic ester-2 (also known as DBE-2), where n can be 3 and/or 4, such as dimethyl glutarate, dimethyl adipate, or a mixture of dimethyl glutarate and dimethyl adipate. In some examples, the dibasic ester can be or include dibasic ester-9 (also known as DBE-9), where n can be 2 and/or 3, such as dimethyl glutarate, dimethyl succinate, or a mixture of dimethyl glutarate and dimethyl succinate. In other examples, the dibasic ester can be or include dibasic ester-4 (also known as DBE-4), where n can be 2, such as dimethyl succinate. In other examples, the dibasic ester can be or include dibasic ester-5 (also known as DBE-5), where n can be 3, such as dimethyl glutarate. In other examples, the dibasic ester can be or include dibasic ester-6 (also known as DBE-6), where n can be 4, such as dimethyl adipate. Illustrative dibasic esters can be or include, but are not limited to, one or more of dimethyl glutarate, dimethyl adipate, dimethyl succinate, or any mixture thereof. In other examples, the dibasic ester can be or include dibasic ester-LVP (also known as DBE-LVP), where n can be 3 or 4 and can include dimethyl adipate and/or dimethyl glutarate.

The composite resin can include the dibasic ester in an amount of about 0.1 wt %, about 0.2 wt %, about 0.3 wt %, or about 0.5 wt % to about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.7 wt %, about 1.9 wt %, about 2 wt %, about 2.1 wt %, about 2.3 wt %, about 2.5 wt %, about 2.7 wt %, about 2.9 wt %, about 3 wt %, about 3.1 wt %, about 3.3 wt %, about 3.5 wt %, about 3.7 wt %, about 3.9 wt %, about 4 wt %, about 4.5 wt %, about 5 wt %, about 6 wt %, about 8 wt %, about 10 wt %, or greater, based on the solids weight of the phenol-formaldehyde resin. For example, the composite resin can include the dibasic ester in an amount of about 0.1 wt % to about 10 wt %, about 0.1 wt % to about 5 wt %, about 0.2 wt % to about 4 wt %, about 0.2 wt % to about 2 wt %, about 0.2 wt % to about 1.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1.5 wt %, about 1 wt % to about 4 wt %, about 1 wt % to about 3 wt %, about 1 wt % to about 2 wt %, or about 1 wt % to about 1.5 wt %, based on the solids weight of the phenol-formaldehyde resin.

The composite resin can include one or more aminosilanes, such as, but not limited to 3-aminopropyltrimethoxysilane, 3-aminopropyltriethoxysilane, N-(beta-aminoethyl) gamma-aminopropyltrimethoxysilane, N-(beta-aminoethyl) gamma-aminopropyltriethoxysilane, 3-glycidoxypropyltrimethoxysilane, 3-glycidoxypropyltriethoxysilane, isomers thereof, salts thereof, or any mixture thereof. The composite resin can include the aminosilane in an amount of about 0.01 wt %, about 0.02 wt %, about 0.03 wt %, or about 0.05 wt % to about 0.06 wt %, about 0.08 wt %, about 0.1 wt %, about 0.11 wt %, about 0.13 wt %, about 0.15 wt %, about 0.17 wt %, about 0.19 wt %, about 0.2 wt %, about 0.21 wt %, about 0.23 wt %, about 0.25 wt %, about 0.27 wt %, about 0.3 wt %, about 0.31 wt %, about 0.33 wt %, about 0.35 wt %, about 0.37 wt %, about 0.4 wt %, about 0.41 wt %, about 0.43 wt %, about 0.45 wt %, about 0.47 wt %, about 0.5 wt %, about 0.55 wt %, about 0.6 wt %, about 0.7 wt %, about 0.8 wt %, about 0.9 wt %, about 1 wt %, about 1.5 wt %, about 2 wt %, about 2.5 wt %, about 3 wt %, or greater, based on the solids weight of the phenol-formaldehyde resin. For example, the composite resin can include the aminosilane in an amount of about 0.01 wt % to about 3 wt %, about 0.02 wt % to about 2 wt %, about 0.02 wt % to about 1 wt %, about 0.05 wt % to about 1.5 wt %, about 0.05 wt % to about 1 wt %, about 0.05 wt % to about 0.7 wt %, about 0.05 wt % to about 0.5 wt %, about 0.1 wt % to about 1.5 wt %, about 0.1 wt % to about 1 wt %, about 0.1 wt % to about 0.7 wt %, about 0.1 wt % to about 0.5 wt %, about 0.2 wt % to about 1.5 wt %, about 0.2 wt % to about 1 wt %, about 0.2 wt % to about 0.7 wt %, or about 0.2 wt % to about 0.5 wt %, based on the solids weight of the phenol-formaldehyde resin.

The composite resin can include one or more waxes, such as, synthetic wax, natural wax, or a mixture thereof. Illustrative waxes can be or include, but are not limited to, paraffin waxes, polyethylene waxes, N,N′-ethylenebis(stearamide) waxes, metallic stearate waxes (e.g., calcium stearate, zinc stearate, lithium stearate), isomers thereof, salts thereof, or any mixture thereof. Illustrative metallic stearate waxes can be or include, but are not limited to, calcium stearate, zinc stearate, aluminum stearate, magnesium stearate, lithium stearate, sodium stearate, potassium stearate, isomers thereof, salts thereof, or any mixture thereof. One illustrative synthetic wax can be or include N,N′-ethylenebis(stearamide), commercially available as ACRAWAX C® wax. In some examples, the composite resin can include synthetic wax beads.

The composite resin can include the wax in an amount of about 0.1 wt %, about 0.2 wt %, about 0.3 wt %, or about 0.5 wt % to about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.7 wt %, about 1.9 wt %, about 2 wt %, about 2.1 wt %, about 2.3 wt %, about 2.5 wt %, about 2.7 wt %, about 2.9 wt %, about 3 wt %, about 3.1 wt %, about 3.3 wt %, about 3.5 wt %, about 3.7 wt %, about 3.9 wt %, about 4 wt %, about 4.5 wt %, about 5 wt %, or greater, based on the solids weight of the phenol-formaldehyde resin. For example, the composite resin can include the wax in an amount of about 0.1 wt % to about 5 wt %, about 0.2 wt % to about 4 wt %, about 0.2 wt % to about 2 wt %, about 0.2 wt % to about 1.5 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1.5 wt %, about 1 wt % to about 4 wt %, about 1 wt % to about 3 wt %, about 1 wt % to about 2 wt %, or about 1 wt % to about 1.5 wt %, based on the solids weight of the phenol-formaldehyde resin.

The composite resin can include one or more pH adjusting agents, such as, one or more acids and/or one or more bases. Illustrative acids can be or include, but are not limited to, sulfuric acid, phosphoric acid, hydrochloric acid, salts thereof, or any mixture thereof. Illustrative bases can be or include, but are not limited to, ammonium hydroxide, lithium hydroxide, sodium hydroxide, potassium hydroxide, urea, urea compounds, amines, salts thereof, or any mixture thereof. In some examples, the composite resin can include sulfuric acid and ammonium hydroxide. The composite resin can include the pH adjusting agent in an amount of about 0.01 wt %, about 0.02 wt %, about 0.03 wt %, or about 0.05 wt % to about 0.06 wt %, about 0.08 wt %, about 0.1 wt %, about 0.11 wt %, about 0.13 wt %, about 0.15 wt %, about 0.17 wt %, about 0.19 wt %, about 0.2 wt %, about 0.21 wt %, about 0.23 wt %, about 0.25 wt %, about 0.27 wt %, about 0.3 wt %, about 0.31 wt %, about 0.33 wt %, about 0.35 wt %, about 0.37 wt %, about 0.4 wt %, about 0.41 wt %, about 0.43 wt %, about 0.45 wt %, about 0.47 wt %, about 0.5 wt %, about 0.55 wt %, about 0.6 wt %, about 0.7 wt %, about 0.8 wt %, about 0.9 wt %, about 1 wt %, about 1.5 wt %, about 2 wt %, about 2.5 wt %, about 3 wt %, or greater, based on the solids weight of the phenol-formaldehyde resin. For example, the composite resin can include the pH adjusting agent in an amount of about 0.01 wt % to about 3 wt %, about 0.02 wt % to about 2 wt %, about 0.02 wt % to about 1 wt %, about 0.05 wt % to about 1.5 wt %, about 0.05 wt % to about 1 wt %, about 0.05 wt % to about 0.7 wt %, about 0.05 wt % to about 0.5 wt %, about 0.1 wt % to about 1.5 wt %, about 0.1 wt % to about 1 wt %, about 0.1 wt % to about 0.7 wt %, about 0.1 wt % to about 0.5 wt %, about 0.2 wt % to about 1.5 wt %, about 0.2 wt % to about 1 wt %, about 0.2 wt % to about 0.7 wt %, or about 0.2 wt % to about 0.5 wt %, based on the solids weight of the phenol-formaldehyde resin. In some examples, the pH adjusting agent can be or include sulfuric acid in an amount of about 0.05 wt % to about 0.4 wt % and ammonium hydroxide in an amount of about 0.1 wt % to about 1 wt %.

The composite resin can include one or more organic acids that can be or include, but are not limited to, salicylic acid, benzoic acid, maleic acid, citric acid, succinic acid, oxalic acid, isomers thereof, salts thereof, hydrates thereof, or any mixture thereof. The composite resin can include the organic acid in an amount of about 0.05 wt %, about 0.07 wt %, about 0.09 wt %, or about 0.1 wt % to about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, about 0.95 wt %, about 1 wt %, about 1.2 wt %, about 1.5 wt %, about 1.7 wt %, about 2 wt %, about 2.5 wt %, about 3 wt %, or greater, based on the solids weight of the phenol-formaldehyde resin. For example, the composite resin can include the organic acid in an amount of about 0.05 wt % to about 3 wt %, about 0.07 wt % to about 2 wt %, about 0.1 wt % to about 3 wt %, about 0.1 wt % to about 2 wt %, about 0.1 wt % to about 1 wt %, about 0.2 wt % to about 3 wt %, about 0.2 wt % to about 2 wt %, about 0.2 wt % to about 1 wt %, about 0.4 wt % to about 3 wt %, about 0.4 wt % to about 2 wt %, or about 0.4 wt % to about 1 wt %, based on the solids weight of the phenol-formaldehyde resin.

The composite resin can include one or more solvents. Illustrative solvents can include, but are not limited to, water, one or more organic solvents, or any mixture thereof. In some examples, the composite resin can include water. The composite resin can include the solvent, e.g., water and/or other solvent, in an amount of about 0.01 wt %, about 0.02 wt %, about 0.03 wt %, or about 0.05 wt % to about 0.06 wt %, about 0.08 wt %, about 0.1 wt %, about 0.11 wt %, about 0.13 wt %, about 0.15 wt %, about 0.17 wt %, about 0.19 wt %, about 0.2 wt %, about 0.21 wt %, about 0.23 wt %, about 0.25 wt %, about 0.27 wt %, about 0.3 wt %, about 0.31 wt %, about 0.33 wt %, about 0.35 wt %, about 0.37 wt %, about 0.4 wt %, about 0.41 wt %, about 0.43 wt %, about 0.45 wt %, about 0.47 wt %, about 0.5 wt %, about 0.55 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 4 wt %, about 5 wt %, about 8 wt %, about 10 wt %, or greater, based on the solids weight of the phenol-formaldehyde resin. For example, the composite resin can include the solvent in an amount of about 0.01 wt % to about 8 wt %, about 0.01 wt % to about 3 wt %, about 0.02 wt % to about 2 wt %, about 0.02 wt % to about 1 wt %, about 0.05 wt % to about 1.5 wt %, about 0.05 wt % to about 1 wt %, about 0.05 wt % to about 0.7 wt %, about 0.05 wt % to about 0.5 wt %, about 0.1 wt % to about 1.5 wt %, about 0.1 wt % to about 1 wt %, about 0.1 wt % to about 0.7 wt %, about 0.1 wt % to about 0.5 wt %, about 0.2 wt % to about 1.5 wt %, about 0.2 wt % to about 1 wt %, about 0.2 wt % to about 0.7 wt %, or about 0.2 wt % to about 0.5 wt %, based on the solids weight of the phenol-formaldehyde resin.

The composite resin, e.g., the phenol-formaldehyde resin and the aluminosilicate clay, can have a viscosity of about 10 cP, about 100 cP, about 500 cP, about 600 cP, about 800 cP, about 1,000 cP, or about 1,200 cP to about 1,300 cP, about 1,400 cP, about 1,500 cP, about 1,600 cP, about 1,700 cP, about 1,800 cP, about 1,900 cP, about 2,000 cP, about 2,200 cP, about 2,400 cP, about 2,600 cP, about 2,800 cP, about 3,000 cP, about 4,000 cP, about 5,000 cP, or greater to a temperature of about 150° C. For example, the composite resin can have a viscosity of about 500 cP to about 3,000 cP, about 1,000 cP to about 3,000 cP, about 1,000 cP to about 2,000 cP, about 1,200 cP to about 1,800 cP, or about 1,300 cP to about 1,700 cP at a temperature of about 150° C. The viscosity of the various compositions discussed and described herein can be heated to a temperature of about 150° C. and can be determined using a viscometer. For example, a Model DVD-II viscometer, commercially available from Brookfield Company, Inc., equipped with a Thermocell set at 150° C. can be used to measure viscosity. A #18 spindle can be used with the RPM's adjusted to keep between about 20% and about 80% of scale reading.

The proppants can be utilized to hold open formation fractures formed during a hydraulic fracturing process. In some examples, each proppant can have a single particle contained therein. In other examples, each proppant can have two or more particles contained therein. The particles can be or include, but are not limited to, sand, gravel, beads, pellets, nut and/or seed media, mineral fibers, natural fibers, synthetic fibers, ceramics, or any mixture thereof. Illustrative sand that can be utilized as particles can be or include, but is not limited to, one or more of frac sand, silica sand, glass, quartz, silicon dioxide, silica, silicates, other silicon oxide sources, or any mixture thereof. The type of sand used as the particles can have a variety of shapes and sizes. The sand may be relatively rounded or have spherical or substantially spherical grains or the sand may be an angular sand having sharp or less rounded grains. Similarly, particulates other than sand, such as ceramics, may be spherical or substantially spherical with rounded edges or angular with sharp or jagged edges.

Illustrative beads and pellets that can be utilized as particles can be or include, but are not limited to, one or more metals (e.g., aluminum, iron, steel, or alloys thereof), glass, sintered bauxite, ceramics (e.g., aluminum, zirconium, hafnium, and/or titanium oxide sources), mineral particulates, synthetic polymers or resins (e.g., nylon, polyethylene, or polypropylene), or any mixture thereof. In some examples, the particles can be or include rigid, substantially spherical pellets or spherical glass beads, such as UCAR® props, commercially available from Union Carbide Corporation. In some examples, particles can be or include metallic beads and/or pellets that contain aluminum, iron, steel, alloys thereof. In some examples, particles can be or include metallic beads and/or pellets that contain ceramics.

The particles can include, but are not limited to, one or more silicon oxide sources (e.g., silica, silicates, silicon dioxide, or other silicon oxides), aluminum oxide sources (e.g., alumina, aluminates, or other aluminum oxides), zirconium oxide sources (e.g., zirconia, zirconium dioxide, or other zirconium oxides), hafnium oxide sources (e.g., hafnia, hafnium dioxide, or other hafnium oxides), titanium oxide sources (e.g., titania, titanium dioxide, or other titanium oxides), carbonate sources, other ceramic materials, other metal oxides, or any mixture thereof.

Nut or seed media can be, include, and/or be produced from, but are not limited to, whole, broken, chopped, crushed, milled, and/or ground nuts, nut shells, seeds, and/or seed hulls, including tree nuts and oil seeds. Illustrative nuts or seeds can include, but are not limited to, almond, walnut, pecan, chestnut, hickory, cashew, peanut, macadamia, sunflower, linseed, rapeseed, castor seed, poppy seed, hemp seed, tallow tree seed, safflower seed, mustard seed, other tree nuts, other oilseeds, or any mixture thereof and can be used in or to produce the nut or seed media.

In some examples, the uncoated proppant or particles can have a mesh size (or equivalent value of average particle size in parenthesis) of about 270 (about 53 μm), about 230 (about 63 μm), about 200 (about 75 μm), about 120 (about 125 μm), or about 100 (about 150 μm) to about 80 (about 180 μm), about 60 (about 250 μm), about 40 (about 425 μm), about 30 (about 600 μm), about 20 (about 850 μm), or about 10 (about 2 mm). For example, the particles can have a mesh size (or equivalent average particle size) of about 270 (about 53 μm) to about 10 (about 2 mm), about 230 (about 63 μm) to about 10 (about 2 mm), about 200 (about 75 μm) to about 10 (about 2 mm), about 200 (about 75 μm) to about 20 (about 850 μm), about 100 (about 150 μm) to about 10 (about 2 mm), or about 100 (about 150 μm) to about 20 (about 850 μm). In other examples, the particles can have a mesh size (or equivalent average particle size) of about 120 (about 125 μm), about 100 (about 150 μm), about 80 (about 180 μm), about 60 (about 250 μm), or about 40 (about 425 μm) to about 30 (about 600 μm), about 20 (about 850 μm), or about 10 (about 2 mm). For example, the particles can have a mesh size (or equivalent average particle size) of about 80 (about 180 μm) to about 40 (about 425 μm), about 80 (about 180 μm) to about 20 (about 850 μm), about 80 (about 180 μm) to about 10 (about 2 mm), about 60 (about 250 μm) to about 40 (about 425 μm), about 60 (about 250 μm) to about 20 (about 850 μm), about 60 (about 250 μm) to about 10 (about 2 mm), about 40 (about 425 μm) to about 30 (about 600 μm), about 40 (about 425 μm) to about 20 (about 850 μm), or about 40 (about 425 μm) to about 10 (about 2 mm).

In some specific examples, the particles can be or include silica sand, frac sand, and/or other sand and can have a mesh size (or equivalent average particle size) of about 40 (about 425 μm) or about 20 (about 850 μm) to about 10 (about 2 mm). In other specific examples, the particles can be gravel, beads, or pellets and can have a mesh size (or equivalent average particle size) of about 200 (about 75 μm) to about 10 (about 2 mm). The mesh size of the particles or proppants described and discussed herein can be measured according to the U.S. Standard Sieve Series and the average particle size of the particles or proppants described and discussed herein can be calculated from the measured mesh size. Further description for measuring and calculating mesh size and average particle size can be found in Measurement of Properties of Proppants Used in Hydraulic Fracturing and Gravel-Packing Operations, ANSI/API Recommended Practice 19C, May 2008, (ISO 13503-2:2006).

In some examples, the method for producing the proppant having the cured resin or the curable resin at least partially covering or completely covering the uncoated particles is provided. In some examples, the cured resin can include the composite resin (e.g., one or more phenol-formaldehyde resins and one or more clays) and one or more cross-linkers (e.g., hexamethylenetetramine). A plurality of particles (e.g., sand), the composite resin, and the cross-linker can be combined in a blender, mixer, or other device to produce the proppant. In some examples, the particles can be heated to a temperature of about 50° C. to about 400° C. or about 100° C. to about 400° C. and combined with the composite resin in the mixer and mixed for about 0.1 min to about 5 min. Thereafter, the cross-linker can be added to the mixture and mixed for about 1 min to about 10 min to produce the proppants. The proppants can be removed from the mixer and allowed to cool to ambient temperature (e.g., about 23° C.) to produce the proppant having the cured resin at least partially covering or completely covering the particles.

In other examples, the method for producing proppants containing the cured resin can include heating the plurality of particles to a temperature of about 100° C. to about 400° C. to produce heated particles, and then adding the composite resin to the heated particles to produce a first mixture. The method can include agitating the first mixture to produce a plurality of coated particles having uncured resin, adding the cross-linker to the plurality of coated particles to produce a second mixture, and heating the second mixture to produce the plurality of proppants containing the cured resin.

In some examples, one or more waxes can be added along with the cross-linker to the plurality of coated particles to produce the second mixture. The cross-linker and the wax can be combined to produce a cross-linker wax blend, and subsequently, the cross-linker wax blend can be mixed or otherwise combined with the plurality of coated particles to produce the second mixture. Alternatively, one or more waxes and one or more cross-linkers can be separately added to the plurality of coated particles to produce the second mixture. Illustrative waxes can be or include, but are not limited to, paraffin waxes, polyethylene waxes, N,N′-ethylenebis(stearamide) waxes, metallic stearate waxes (e.g., calcium stearate, zinc stearate, lithium stearate), isomers thereof, salts thereof, or any mixture thereof. Illustrative metallic stearate waxes can be or include, but are not limited to, calcium stearate, zinc stearate, aluminum stearate, magnesium stearate, lithium stearate, sodium stearate, potassium stearate, isomers thereof, salts thereof, or any mixture thereof. In one or more examples, the cross-linker wax blend can include N,N′-ethylenebis(stearamide), commercially available as ACRAWAX C® wax.

The cross-linker wax blend can include the cross-linker in an amount of about 75 wt % to about 99 wt % and the wax in an amount of about 1 wt % to about 25 wt %, based on a total weight of the cross-linker and the wax. For example, the cross-linker wax blend can include the cross-linker in an amount of about 75 wt %, about 80 wt %, about 85 wt %, about 88 wt %, or about 90 wt % to about 92 wt %, about 94 wt %, about 95 wt %, about 96 wt %, about 98 wt %, or about 99 wt %, based on a total weight of the cross-linker and the wax. The cross-linker wax blend can include the wax in an amount of about 1 wt %, about 2 wt %, about 4 wt %, about 5 wt %, about 6 wt %, about 8 wt %, or about 10 wt % to about 12 wt %, about 15 wt %, about 20 wt %, or about 25 wt %, based on a total weight of the cross-linker and the wax.

In some examples, the uncoated particles can be heated to a temperature of about 50° C., about 80° C., about 100° C., or about 120° C. to about 150° C., about 180° C., about 200° C., about 250° C., about 300° C., about 350° C., about 400° C., about 450° C. or greater when contacted with the composite resin and/or the cross-linker. For example, the particles can be heated to a temperature about 50° C. to about 400° C., about 100° C. to about 400° C., about 200° C. to about 400° C., or about 300° C. to about 400° C. when contacted with the composite resin and/or the cross-linker.

The heated particles and the composite resin can be combined and mixed for about 0.1 min, about 0.2 min, about 0.3 min, or about 0.4 min to about 0.6 min, about 0.7 min, about 0.8 min, about 0.9 min, or about 1 min to about 2 min, about 3 min, about 4 min, or about 5 min. For example, the heated particles and the composite resin can be mixed for about 0.1 min to about 5 min, about 0.2 min to about 3 min, about 0.3 min to about 1 min, about 0.2 min to about 0.8 min, or about 0.4 min to about 0.6 min. The particles, the composite resin, and the cross-linker can be mixed for about 1 min, about 1.5 min, or about 2 min to about 3 min, about 5 min, about 7 min, or about 10 min. For example, the particles, the composite resin, and the cross-linker can be mixed for about 1 min to about 10 min, about 1 min to about 5 min, about 1 min to about 3 min, or about 1 min to about 2 min. Additional details related to methods for producing proppants can include those discussed and described in U.S. Pat. Nos. 8,003,214; 8,133,587; and 8,778,495.

One or more cross-linkers can be applied to or combined with the coated particles, the composite resin, or a mixture of the composite resin and the plurality of particles to produce the cured composite resin and/or a plurality of proppants. Illustrative cross-linkers can be or include, but are not limited to, hexamethylenetetramine, bismethylol cresols, bisoxazolines (e.g., BOX or PyBOX class of ligands), bisbenzoxazines, epoxy resins, phenol-formaldehyde resole resins, solid resole polymers or resins, isomers thereof, solutions thereof, or any mixture thereof. In one or more examples, the cross-linker can be or include hexamethylenetetramine (also referred to as hexamine).

In some examples, the cross-linker can be combined with the composite resin and the plurality of particles in an amount of and/or the cured resin can include the cross-linker in an amount of about 0.01 wt %, about 0.02 wt %, about 0.03 wt %, about 0.05 wt %, about 0.07 wt %, about 0.09 wt %, or about 0.1 wt % to about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.9 wt %, about 1 wt %, about 1.1 wt %, about 1.2 wt %, about 1.3 wt %, about 1.5 wt %, about 1.7 wt %, about 1.9 wt %, about 2 wt %, about 2.5 wt %, about 3 wt %, about 4 wt %, or about 5 wt %, based on the dry weight of the particles. For example, the cross-linker can be combined with the composite resin and the plurality of particles and/or the cured resin can include the cross-linker in an amount of about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.05 wt % to about 0.5 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.5 wt %, about 0.2 wt % to about 5 wt %, about 0.2 wt % to about 4 wt %, about 0.2 wt % to about 3 wt %, about 0.2 wt % to about 2 wt %, about 0.2 wt % to about 1 wt %, about 0.2 wt % to about 0.5 wt %, about 0.3 wt % to about 5 wt %, about 0.3 wt % to about 4 wt %, about 0.3 wt % to about 3 wt %, about 0.3 wt % to about 2 wt %, about 0.3 wt % to about 1 wt %, or about 0.3 wt % to about 0.5 wt %, based on the dry weight of the particles.

In other examples, the cross-linker can be combined with at least one or more resins (e.g., the phenol-formaldehyde resin or the composite resin) and the plurality of particles in an amount of and/or the cured resin can include the cross-linker in an amount of about 1 wt %, about 2 wt %, about 4 wt %, about 6 wt %, or about 8 wt % to about 10 wt %, about 12 wt %, about 14 wt %, about 15 wt %, about 18 wt %, about 20 wt %, or greater, based on the solids weight of the phenol-formaldehyde resin.

For example, the cross-linker can be combined with at least one or more resins (e.g., the phenol-formaldehyde resin or the composite resin) and the plurality of particles in an amount of and/or the cured resin can include the cross-linker in an amount of about 1 wt % to about 20 wt %, about 1 wt % to about 18 wt %, about 1 wt % to about 15 wt %, about 1 wt % to about 12 wt %, about 1 wt % to about 10 wt %, about 1 wt % to about 8 wt %, about 1 wt % to about 6 wt %, about 1 wt % to about 4 wt %, about 5 wt % to about 20 wt %, about 5 wt % to about 18 wt %, about 5 wt % to about 15 wt %, about 5 wt % to about 12 wt %, about 5 wt % to about 10 wt %, about 5 wt % to about 8 wt %, about 5 wt % to about 6 wt %, about 8 wt % to about 20 wt %, about 8 wt % to about 18 wt %, about 8 wt % to about 15 wt %, about 8 wt % to about 12 wt %, or about 8 wt % to about 10 wt %, based on the solids weight of the phenol-formaldehyde resin.

In other examples, the cured resin can include the cross-linker in an amount of about 1 wt %, about 2 wt %, about 3 wt %, about 4 wt %, or about 5 wt % to about 6 wt %, about 8 wt %, about 10 wt %, about 11 wt %, about 12 wt %, about 13 wt %, about 15 wt %, about 16 wt %, about 18 wt %, about 20 wt %, about 22 wt %, about 24 wt %, about 25 wt %, about 26 wt %, about 28 wt %, or about 30 wt %, based on the solids weight of the composite resin. For example, the cured resin can include the cross-linker in an amount of about 1 wt % to about 30 wt %, about 2 wt % to about 20 wt %, about 3 wt % to about 20 wt %, about 4 wt % to about 20 wt %, about 5 wt % to about 20 wt %, about 8 wt % to about 20 wt %, about 10 wt % to about 20 wt %, about 2 wt % to about 15 wt %, about 3 wt % to about 15 wt %, about 4 wt % to about 15 wt %, about 5 wt % to about 15 wt %, about 8 wt % to about 15 wt %, or about 10 wt % to about 15 wt %, based on the solids weight of the composite resin.

The proppant can include one or more particles at least partially covered or encased or completely covered or encased with the cured resin and/or the curable resin. The cured resin containing one or more phenol-formaldehyde resins and one or more clays can provide or produce a proppant having a dry crush strength of a surprisingly and unexpectedly discovered value in comparison to traditional proppants. The dry crush strengths of the proppant discussed and described herein can be measured or determined at a pressure of about 55.2 MPa (about 8,000 psi) and at a pressure of about 82.7 MPa (about 12,000 psi). The dry crush strengths can be measured or determined measured according to the Proppant Crush Resistance Test Procedure under ISO 13503-2:2011 modified according to the procedure discussed and described above that uses a different cell, amount of sample, and applies the pressure manually for and holds the applied pressure for 30 seconds instead of applying the pressure continuously and holding the applied pressure for 2 minutes. In another example, the dry crush strengths can be measured or determined measured according to the Proppant Crush Resistance Test Procedure under ISO 13503-2:2011 without any modifications to the test procedure.

The proppant can have a dry crush strength of about 0.1 wt %, about 0.2 wt %, about 0.3 wt %, about 0.5 wt %, about 0.7 wt %, or about 0.9 wt % to about 1 wt %, about 1.2 wt %, about 1.5 wt %, about 1.7 wt %, about 2 wt %, about 2.2 wt %, about 2.5 wt %, about 2.7 wt %, about 3 wt %, about 3.2 wt %, about 3.5 wt %, about 3.7 wt %, about 4 wt %, about 4.2 wt %, about 4.5 wt %, about 4.7 wt %, about 5 wt %, about 5.2 wt %, about 5.5 wt %, about 5.7 wt %, about 6 wt %, about 6.5 wt %, or about 7 wt %, at a pressure of about 55.2 MPa (about 8,000 psi). For example, the proppant can have a dry crush strength of about 0.1 wt % to about 5 wt %, about 0.1 wt % to about 4.5 wt %, about 0.1 wt % to about 4 wt %, about 0.1 wt % to about 3.5 wt %, about 0.1 wt % to about 3 wt %, about 0.1 wt % to about 2.5 wt %, about 0.1 wt % to about 2 wt %, about 0.1 wt % to about 1.5 wt %, about 0.1 wt % to about 1 wt %, about 0.1 wt % to about 0.5 wt %, at a pressure of about 55.2 MPa. In some examples, the proppant can have a dry crush strength of about 0.2 wt % to about 5 wt %, about 0.2 wt % to about 4.5 wt %, about 0.2 wt % to about 4 wt %, about 0.2 wt % to about 3.5 wt %, about 0.2 wt % to about 3 wt %, about 0.2 wt % to about 2.5 wt %, about 0.2 wt % to about 2 wt %, about 0.2 wt % to about 1.5 wt %, about 0.2 wt % to about 1 wt %, about 0.2 wt % to about 0.5 wt %, at a pressure of about 55.2 MPa. In other examples, the proppant can have a dry crush strength of about 0.5 wt % to less than 5 wt %, about 0.5 wt % to less than 4.5 wt %, about 0.5 wt % to less than 4 wt %, about 0.5 wt % to less than 3.5 wt %, about 0.5 wt % to less than 3 wt %, about 0.5 wt % to less than 2.5 wt %, about 0.5 wt % to less than 2 wt %, about 0.5 wt % to less than 1.5 wt %, or about 0.5 wt % to less than 1 wt %, at a pressure of about 55.2 MPa. In another example, the proppant can have a dry crush strength of less than 5 wt %, less than 4.5 wt %, less than 4 wt %, less than 3.5 wt %, less than 3 wt %, less than 2.5 wt %, less than 2 wt %, less than 1.5 wt %, less than 1 wt %, or less than 0.5 wt %, at a pressure of about 55.2 MPa.

The proppant can have a dry crush strength of about 0.3 wt %, about 0.5 wt %, about 0.9 wt % to about 1 wt %, about 1.5 wt %, about 2 wt %, about 2.5 wt %, about 2.7 wt % or about 3 wt % to about 3.2 wt %, about 3.5 wt %, about 4 wt %, about 4.2 wt %, about 4.5 wt %, about 4.7 wt %, about 5 wt %, about 5.2 wt %, about 5.5 wt %, about 5.7 wt %, about 6 wt %, about 6.2 wt %, about 6.5 wt %, about 6.7 wt %, about 7 wt %, about 7.2 wt %, about 7.5 wt %, about 7.7 wt %, about 8 wt %, about 8.2 wt %, about 8.5 wt %, about 8.7 wt %, about 9 wt %, about 9.2 wt %, about 9.5 wt %, about 9.7 wt %, about 10 wt %, about 10.2 wt %, about 10.5 wt %, about 10.7 wt %, about 11 wt %, about 11.5 wt %, about 12 wt %, or greater at a pressure of about 82.7 MPa (about 12,000 psi). For example, the proppant can have a dry crush strength of about 0.3 wt % to about 12 wt %, about 0.5 wt % to about 12 wt %, about 1 wt % to about 12 wt %, about 2 wt % to about 12 wt %, about 4 wt % to about 12 wt %, about 5 wt % to about 12 wt %, about 6 wt % to about 12 wt %, about 7 wt % to about 12 wt %, about 8 wt % to about 12 wt %, about 9 wt % to about 12 wt %, about 10 wt % to about 12 wt %, about 0.5 wt % to about 11 wt %, about 1 wt % to about 11 wt %, about 2 wt % to about 11 wt %, about 4 wt % to about 11 wt %, about 5 wt % to about 11 wt %, about 6 wt % to about 11 wt %, about 7 wt % to about 11 wt %, about 8 wt % to about 11 wt %, about 9 wt % to about 11 wt %, about 10 wt % to about 11 wt %, about 0.5 wt % to about 10 wt %, about 1 wt % to about 10 wt %, about 2 wt % to about 10 wt %, about 4 wt % to about 10 wt %, about 5 wt % to about 10 wt %, about 6 wt % to about 10 wt %, about 7 wt % to about 10 wt %, about 8 wt % to about 10 wt %, about 9 wt % to about 10 wt %, about 0.5 wt % to about 9 wt %, about 1 wt % to about 9 wt %, about 2 wt % to about 9 wt %, about 4 wt % to about 9 wt %, about 5 wt % to about 9 wt %, about 6 wt % to about 9 wt %, about 7 wt % to about 9 wt %, about 8 wt % to about 9 wt %, about 0.5 wt % to about 8 wt %, about 1 wt % to about 8 wt %, about 2 wt % to about 8 wt %, about 4 wt % to about 8 wt %, about 5 wt % to about 8 wt %, about 6 wt % to about 8 wt %, about 7 wt % to about 8 wt %, at a pressure of about 82.7 MPa. In other examples, the proppant can have a dry crush strength of about 0.3 wt % to less than 12 wt %, about 0.5 wt % to less than 12 wt %, about 1 wt % to less than 12 wt %, about 2 wt % to less than 12 wt %, about 4 wt % to less than 12 wt %, about 5 wt % to less than 12 wt %, about 6 wt % to less than 12 wt %, about 7 wt % to less than 12 wt %, about 8 wt % to less than 12 wt %, about 9 wt % to less than 12 wt %, about 10 wt % to less than 12 wt %, about 0.5 wt % to less than 11 wt %, about 1 wt % to less than 11 wt %, about 2 wt % to less than 11 wt %, about 4 wt % to less than 11 wt %, about 5 wt % to less than 11 wt %, about 6 wt % to less than 11 wt %, about 7 wt % to less than 11 wt %, about 8 wt % to less than 11 wt %, about 9 wt % to less than 11 wt %, about 10 wt % to less than 11 wt %, about 0.5 wt % to less than 10 wt %, about 1 wt % to less than 10 wt %, about 2 wt % to less than 10 wt %, about 4 wt % to less than 10 wt %, about 5 wt % to less than 10 wt %, about 6 wt % to less than 10 wt %, about 7 wt % to less than 10 wt %, about 8 wt % to less than 10 wt %, about 9 wt % to less than 10 wt %, about 0.5 wt % to less than 9 wt %, about 1 wt % to less than 9 wt %, about 2 wt % to less than 9 wt %, about 4 wt % to less than 9 wt %, about 5 wt % to less than 9 wt %, about 6 wt % to less than 9 wt %, about 7 wt % to less than 9 wt %, about 8 wt % to less than 9 wt %, about 0.5 wt % to less than 8 wt %, about 1 wt % to less than 8 wt %, about 2 wt % to less than 8 wt %, about 4 wt % to less than 8 wt %, about 5 wt % to less than 8 wt %, about 6 wt % to less than 8 wt %, about 7 wt % to less than 8 wt %, at a pressure of about 82.7 MPa. In another example, the proppant can have a dry crush strength of less than 10 wt %, less than 9.5 wt %, less than 9 wt %, less than 8.5 wt %, less than 8 wt %, less than 7.5 wt %, less than 7 wt %, less than 6.5 wt %, less than 6 wt %, less than 5.5 wt %, less than 5 wt %, less than 4.5 wt %, less than 4 wt %, less than 3.5 wt %, less than 3 wt %, less than 2.5 wt %, less than 2 wt %, less than 1.5 wt %, less than 1 wt %, or less than 0.5 wt %, or less, at a pressure of about 82.7 MPa.

The coating on the proppant can have a thickness of about 0.1 mil (2.54 μm), about 0.2 mil (5.08 μm), about 0.3 mil (7.62 μm), about 0.5 mil (12.7 μm), about 0.7 mil (17.8 μm), or about 0.9 mil (22.9 μm), to about 1 mil (25.4 μm), about 2 mil (50.8 μm), about 3 mil (76.2 μm), about 4 mil (102 μm), about 5 mil (127 μm), about 6 mil (152 μm), about 7 mil (178 μm), about 8 mil (203 μm), about 9 mil (229 μm), about 10 mil (254 μm), about 15 mil (381 μm), about 20 mil (508 μm), or greater. For example, the coating on the proppant can have a thickness of about 0.1 mil (2.54 μm) to about 20 mil (508 μm), about 0.1 mil (2.54 μm) to about 10 mil (254 μm), or about 0.1 mil (2.54 μm) to about 5 mil (127 μm). In some examples, the proppant can have a cured resin with a thickness of about 0.1 mil (2.54 μm) to about 10 mil (254 μm) or about 0.1 mil (2.54 μm) to about 5 mil (127 μm).

The amount or weight of the composite resin, uncured or cured, on the proppants can be based on the weight of the uncoated particle. The composite resin can be combined with the plurality of particles in an amount of and/or the proppants can include the composite resin in an amount of about 0.5 wt %, about 0.7 wt %, about 0.9 wt %, or about 1 wt % to about 1.1 wt %, about 1.3 wt %, about 1.5 wt %, about 1.7 wt %, about 2 wt %, about 2.1 wt %, about 2.3 wt %, about 2.5 wt %, about 2.7 wt %, about 2.9 wt %, about 3 wt %, about 3.1 wt %, about 3.3 wt %, about 3.5 wt %, about 3.7 wt %, about 3.9 wt %, about 4 wt %, about 4.1 wt %, about 4.3 wt %, about 4.5 wt %, about 4.7 wt %, about 4.9 wt %, about 5 wt %, about 5.5 wt %, about 6 wt %, about 6.5 wt %, about 7 wt %, about 7.5 wt %, about 8 wt %, about 8.5 wt %, about 9 wt %, about 10 wt %, about 11 wt %, about 12 wt %, or greater, based on the dry weight of the particles. For example, the composite resin can be combined with the plurality of particles in an amount of and/or the proppants can include the composite resin in an amount of about 0.5 wt % to about 12 wt %, about 1 wt % to about 10 wt %, about 1 wt % to about 8 wt %, about 1 wt % to about 6 wt %, about 1 wt % to about 5 wt %, about 2 wt % to about 10 wt %, about 2 wt % to about 8 wt %, about 2 wt % to about 6 wt %, about 2 wt % to about 5 wt %, about 3 wt % to about 10 wt %, about 3 wt % to about 8 wt %, about 3 wt % to about 6 wt %, or about 3 wt % to about 5 wt %, based on the dry weight of the particles. In some examples, the composite resin can be combined with the plurality of particles in an amount of about 0.5 wt % to about 10 wt %, about 1 wt % to about 5 wt %, or about 2 wt % to about 4 wt %, based on a dry weight of the particles.

The amount or weight of the cured resin on the proppants can also be based on the total weight of the cured resin and the uncoated particle. The amount or weight of the coating on the proppant can be about 0.2 wt %, about 0.5 wt %, about 0.7 wt %, about 0.9 wt %, or about 1 wt % to about 5 wt %, about 6 wt %, about 7 wt %, about 8 wt %, about 9 wt %, about 10 wt %, or about 12 wt %, based on the total weight of the coating and the particle. For example, the coating on the proppant can be about 0.2 wt % to about 12 wt %, about 0.5 wt % to about 10 wt %, about 0.5 wt % to about 5 wt %, about 1 wt % to about 12 wt %, about 1 wt % to about 10 wt %, or about 1 wt % to about 5 wt % of the proppant, based on the total weight of the cured resin and the particles. In some examples, the proppant can have a cured resin that can be about 0.5 wt % to about 10 wt % or about 1 wt % to about 12 wt % of the proppant, based on the total weight of the cured resin and the particles.

The proppant can have a mesh size (or equivalent average particle size) of about 230 (about 63 μm), about 200 (about 75 μm), about 120 (about 125 μm), or about 100 (about 150 μm) to about 80 (about 180 μm), about 60 (about 250 μm), about 40 (about 425 μm), about 30 (about 600 μm), about 20 (about 850 μm), about 10 (about 2 mm), about 8 (about 2.38 mm), about 6 (about 3.36 mm), or about 4 (about 4.76 mm). For example, the proppant can have a mesh size (or equivalent average particle size) of about 200 (about 75 μm) to about 4 (about 4.76 mm), about 200 (about 75 μm) to about 6 (about 3.36 mm), about 200 (about 75 μm) to about 20 (about 850 μm), about 200 (about 75 μm) to about 80 (about 180 μm), about 100 (about 150 μm) to about 4 (about 4.76 mm), about 100 (about 150 μm) to about 6 (about 3.36 mm), about 100 (about 150 μm) to about 20 (about 850 μm), or about 100 (about 150 μm) to about 80 (about 180 μm). In another example, the proppant can have a mesh size (or equivalent average particle size) of about 100 (about 150 μm), about 80 (about 180 μm), or about 60 (about 250 μm) to about 40 (about 425 μm), about 30 (about 600 μm), about 20 (about 850 μm), about 10 (about 2 mm), about 8 (about 2.38 mm), about 6 (about 3.36 mm), or about 4 (about 4.76 mm). In another example, the proppant can have a mesh size (or equivalent average particle size) of about 100 (about 150 μm) to about 4 (about 4.76 mm), about 100 (about 150 μm) to about 6 (about 3.36 mm), about 100 (about 150 μm) to about 20 (about 850 μm), about 80 (about 180 μm) to about 4 (about 4.76 mm), about 80 (about 180 μm) to about 6 (about 3.36 mm), about 80 (about 180 μm) to about 20 (about 850 μm), about 60 (about 250 μm) to about 4 (about 4.76 mm), about 60 (about 250 μm) to about 8 (about 2.38 mm), or about 60 (about 250 μm) to about 20 (about 850 μm). In some specific examples, the proppant can have a mesh size (or equivalent average particle size) of about 40 (about 425 μm) to about 4 (about 4.76 mm), about 40 (about 425 μm) to about 20 (about 850 μm), about 20 (about 850 μm) to about 4 (about 4.76 mm), or about 10 (about 2 mm) to about 4 (about 4.76 mm). In some examples, the plurality of particles can be or include sand and the proppants can have an average particle size of about 180 μm to about 2 mm.

In some examples, a method for making the proppants can include combining one or more phenol-formaldehyde resins and the halloysite having hollow tubular structures to produce the composite resin, coating the plurality of particles with the composite resin and one or more cross-linkers, and reacting the composite resin and the cross-linker to produce the plurality of proppants that include the particles coated with the cured resin. The plurality of proppants can include a plurality of particles and a cured composite resin covering the plurality of particles. Each of the particles can be partially or completely covered by a continuous layer of the cured composite resin. The cured composite resin can be or include one or more phenol-formaldehyde resins and halloysite having hollow tubular structures. The cured composite resin can be greater than 25 wt % to about 50 wt % of the halloysite, based on a solids weight of the phenol-formaldehyde resin. Each proppant can include a particle completely covered by a continuous layer of the cured resin. The plurality of proppants can have a dry crush strength of about 0.5 wt % to less than 10 wt % at a pressure of about 82.7 MPa and/or about 0.1 wt % to about 5 wt % at a pressure of about 55.2 MPa, measured according to the Proppant Crush Resistance Test Procedure under ISO 13503-2:2011 or the Proppant Crush Resistance Test Procedure under ISO 13503-2:2011, modified according to the procedure discussed and described above. In another example, the plurality of proppants can have a dry crush strength of about 0.5 wt % to less than 10 wt % at a pressure of about 82.7 MPa and/or about 0.1 wt % to about 5 wt % at a pressure of about 55.2 MPa, measured according to the Proppant Crush Resistance Test Procedure under ISO 13503-2:2011 without any modifications to the test procedure.

In other examples, the phenol-formaldehyde resin and the aluminosilicate clay (e.g., halloysite) can be combined to produce the composite resin. The phenol-formaldehyde resin having a solid state can be heated to produce a molten phenol-formaldehyde resin. The aluminosilicate clay can be added to the molten phenol-formaldehyde resin to produce a mixture that can be agitated to produce a dispersion containing the molten phenol-formaldehyde resin and the aluminosilicate clay. The phenol-formaldehyde resin having the solid state can be heated to a temperature of about 50° C. to about 300° C., about 100° C. to about 200° C., about 115° C. to about 175° C., about 130° C. to about 150° C., or about 140° C. to about 145° C. to produce the molten phenol-formaldehyde resin. The molten dispersion can be cooled to produce the composite resin containing the aluminosilicate clay and having a solid state.

The proppants discussed and described herein can be utilized in processes and applications, such as, but not limited to, hydraulic fracturing, gravel packing, and/or well formation treatments. In some examples, a method for treating a subterranean formation can include introducing a fluid that contains a plurality of proppants into a wellbore, and introducing the plurality of proppants into the subterranean formation via the wellbore. Each proppant can include the cured resin at least partially or completely encasing a particle, where the cured resin can include the product of the phenol-formaldehyde resin and the clay, where the clay can include the aromatic clay, a poly(C2-C5 alkylene) clay, or a mixture thereof.

In some examples, the method can include servicing the subterranean formation with the plurality of proppants. The subterranean formation can be serviced with the proppants by introducing the proppants into desirable portions or areas of the wellbores and/or the subterranean formations, such as in fractures, cracks, holes, openings, and other orifices within the wellbores and/or the subterranean formations including the sidewalls or surfaces thereof. The proppants can be used in processes or treatments typically performed in wellbores and/or subterranean formations, including, but not limited to, hydraulic fracturing, gravel packing, and well formation treatments.

An agglomerated framework of proppants in the subterranean formation can reduce solid particle flow-back and/or the transport of formation fines from the subterranean formation. Additional details related to methods for using the proppants having the cured resin can include those discussed and described in U.S. Pat. Nos. 8,003,214; 8,133,587; and 8,778,495.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

The unpurified halloysite clay used to make the resin in Example 1 was DRAGONITE® HP halloysite clay and the purified halloysite clay used to make the resin in Example 2 was DRAGONITE® HP:KT purified halloysite clay, both commercially available from Applied Minerals, Inc. The unpurified halloysite clay used in Examples 1 and 4 contained equal to or greater than 95 wt % to less than 98.5 wt % of hydrous aluminum silicate and equal to or greater than 1.5 wt % to less than 5 wt % of quartz. The purified halloysite clay used in Examples 2 and 5 contained equal to or greater than 98.5 wt % to about 99.999 wt % of hydrous aluminum silicate and about 0.01 wt % to less than 1.5 wt % of quartz.

The melt viscosities for Examples 1-3 were measured with a BROOKFIELD® DVD-II viscometer equipped with a Thermocell set at 150° C. A #18 spindle was used with the RPM's adjusted to keep between about 20% and about 80% of scale reading.

### Example 1: PF Resin with Unpurified Halloysite

A 2 L glass resin kettle equipped with a temperature controlled heating mantle, thermometer, and agitator, was charged with about 1,000 g of a PF novolac resin in powder form (GP XPLOR™ 664G26 PF resin, commercially available from Georgia-Pacific Chemicals LLC). The heating mantel was turned on and the PF novolac resin within the kettle was heated to a temperature of about 143° C. After heating for about 30 min, the PF novolac resin became molten. About 250 g of unpurified halloysite (DRAGONITE®-HP halloysite clay, commercially available from Applied Minerals, Inc.) in powder form was added to the molten PF novolac resin. The mixture was agitated and heated at about 143° C. to disperse the unpurified halloysite throughout the molten PF novolac resin and produce a molten composite resin. After agitating and heating for about 15 min, the molten composite resin was poured out of the kettle onto a cooling pan lined in aluminum foil. The molten composite resin cooled to ambient temperature (about 23° C.) and solidified into a thin sheet of the composite resin having a thickness of about 6 mm. The thin sheet of composite resin was struck with a hammer to break into pieces of about 0.5 cm×about 0.5 cm×about 0.6 cm to about 1 cm×about 1 cm×about 0.6 cm. A sample of the thin sheet was analyzed via a Brookfield DVD-II viscometer and the viscosity was determined to be about 1,300 cP at about 150° C.

### Example 2: PF Resin with Purified Halloysite

A 2 L glass resin kettle equipped with a temperature controlled heating mantle, thermometer, and agitator, was charged with about 1,000 g of a PF novolac resin in powder form (GP XPLOR™ 664G26 PF resin, commercially available from Georgia-Pacific Chemicals LLC). The heating mantel was turned on and the PF novolac resin within the kettle was heated to a temperature of about 143° C. After heating for about 30 min, the PF novolac resin became molten. About 250 g of purified halloysite (DRAGONITE®-HP:KT purified halloysite clay, commercially available from Applied Minerals, Inc.) in powder form was added to the molten PF novolac resin. The mixture was agitated and heated at about 143° C. to disperse the purified halloysite throughout the molten PF novolac resin and produce a molten composite resin. After agitating and heating for about 15 min, the molten composite resin was poured out of the kettle onto a cooling pan lined in aluminum foil. The molten composite resin cooled to ambient temperature (about 23° C.) and solidified into a thin sheet of the composite resin having a thickness of about 6 mm. The thin sheet of composite resin was struck with a hammer to break into pieces of about 0.5 cm×about 0.5 cm×about 0.6 cm to about 1 cm×about 1 cm×about 0.6 cm. A sample of the thin composite sheet was analyzed via a Brookfield DVD-II viscometer and the viscosity was determined to be about 1,850 cP at about 150° C.

### Comparative Example 3: PF Resin without Halloysite

A 2 L glass resin kettle equipped with a temperature controlled heating mantle, thermometer, and agitator, was charged with about 1,000 g of a PF novolac resin in powder form (GP XPLOR™ 664G26 PF resin, commercially available from Georgia-Pacific Chemicals LLC). The heating mantel was turned on and the PF novolac resin within the kettle was heated to a temperature of about 143° C. After heating for about 30 min, the PF novolac resin became molten. After agitating and heating for about another 15 min, the molten resin was poured out of the kettle onto a cooling pan lined in aluminum foil. The molten resin cooled to ambient temperature (about 23° C.) and solidified into a thin resin sheet of the resin having a thickness of about 6 mm. The thin resin sheet was struck with a hammer to break into pieces of about 0.5 cm×about 0.5 cm×about 0.6 cm to about 1 cm×about 1 cm×about 0.6 cm. A sample of the thin resin sheet was analyzed via a Brookfield DVD-II viscometer and the viscosity was determined to be about 950 cP at about 150° C.

For Examples 4-6, proppants were produced by coating sand particles with PF resins. Specifically, in Examples 4-6, sand particles were coated with the PF novolac resins prepared in Examples 1-3, respectively. The sand used was 20/40 frac sand, commercially available from Unimin Corporation. The “hexamine-wax blend” used was a solid mixture containing about 90 wt % of hexamethylenetetramine and about 10 wt % of ethylene bis(stearamide) (EBS) wax. All dry crush strength values measured in Examples 4-6 were determined measured according to the Proppant Crush Resistance Test Procedure under ISO 13503-2:2011 modified according to the procedure described above and below. The product properties for Examples 4-6 are provided below in Table 1.

### Example 4

About 2,000 g of sand (preheated to about 274° C.) was added to a 20 L stainless bowl of a food type planetary mixer equipped with the flat beater paddle and an infrared temperature gun. The mixer was run and the temperature of the sand was monitored. Once the temperature of the sand was about 257° C., about 60 g of the Example 1 resin-clay composite pieces (made with unpurified halloysite) were added to the sand. The mixer was run for about 45 sec and about 8 g of the hexamine-wax blend was added to the mixture. The mixture was continuously mixed until about 135 sec had elapsed from when the hexamine-wax blend was added to the mixture. Thereafter, the proppants were discharged from the mixer and allowed to cool in the ambient to about 23° C. The dry crush value was determined to be about 2.4 wt % at about 55.2 MPa (about 8,000 psi) and about 7.4 wt % at about 82.7 MPa (about 12,000 psi).

### Example 5

About 2,000 g of sand (preheated to about 274° C.) was added to a 20 L stainless bowl of a food type planetary mixer equipped with the flat beater paddle and an infrared temperature gun. The mixer was run and the temperature of the sand was monitored. Once the temperature of the sand was about 257° C., about 60 g of the Example 2 resin-clay composite pieces (made with purified halloysite) were added to the sand. The mixer was run for about 45 sec and about 8 g of the hexamine-wax blend was added to the mixture. The mixture was continuously mixed until about 135 sec had elapsed from when the hexamine-wax blend was added to the mixture. Thereafter, the proppants were discharged from the mixer and allowed to cool in the ambient to about 23° C. The dry crush value was determined to be about 3.5 wt % at about 55.2 MPa (about 8,000 psi) and about 8.4 wt % at about 82.7 MPa (about 12,000 psi).

### Comparative Example 6

About 2,000 g of sand (preheated to about 274° C.) was added to a 20 L stainless bowl of a food type planetary mixer equipped with the flat beater paddle and an infrared temperature gun. The mixer was run and the temperature of the sand was monitored. Once the temperature of the sand was about 257° C., about 60 g of the Example 3 control resin pieces (made without halloysite) were added to the sand. The mixer was run for about 45 sec and about 8 g of the hexamine-wax blend was added to the mixture. The mixture was continuously mixed until about 135 sec had elapsed from when the hexamine-wax blend was added to the mixture. Thereafter, the proppants were discharged from the mixer and allowed to cool in the ambient to about 23° C. The dry crush value was determined to be about 2.9 wt % at about 55.2 MPa (about 8,000 psi) and about 10.8 wt % at about 82.7 MPa (about 12,000 psi).

TABLE 1
Dry Crush Strength of Proppants

| | | Dry | Crush |
|---|---|---|---|
| | | Crush | Pressure |
| Examples | Clay in Resin | (wt %) | (MPa) |
| Ex. 4 | unpurified | 2.4 | 55.2 |
| | halloysite | 7.4 | 82.7 |
| Ex. 5 | purified | 3.5 | 55.2 |
| | halloysite | 8.4 | 82.7 |
| CEx. 6 | no added | 2.9 | 55.2 |
| | clay | 10.8 | 82.7 |

The proppants (coated sand particles) were sieved using two sieves, a first sieve (a #20 mesh sieve) and a second sieve (a #40 mesh sieve). The proppants that passed through the first sieve having an average particle size of less than 850 μm were kept and the proppants that did not pass through the first sieve having an average particle size of 850 μm or greater were rejected. The proppants that passed through the first sieve were exposed to the second sieve. The proppants that passed through the second sieve having an average particle size of less than 425 μm were rejected and the proppants that did not pass through the second sieve having an average particle size of 425 μm or greater were kept and used in the dry crush strength tests.

The dry crush strength values in Examples 4 and 5 and Comparative Example 6 were measured with a stainless steel cylinder that had upper and lower movable stainless steel pistons. The body of the cylinder was about 7.63 cm in length and included a removable bottom piston that extended about 1.30 cm into the bottom of the cylinder that provided the base. The removable upper piston was about 7.75 cm in length. The internal diameter of the pistons were about 2.87 cm, which provided a surface area of about 6.44 cm². The volume required to provide a loading of about 1.95 g/cm² was calculated as follows: 1.22 cm³/cm²×3.14×(2.87 cm/2)² or 7.89 cm³. With the density of 20/40 at 1.60 g/cm³ the weight of the sample was about 12.6 g. The pressure was manually applied and held at the applied pressure for about 30 seconds instead of two minutes. The additional conditions and steps in carrying out the dry crus strength tests were the same as those in the standardized ISO 13503-2:2011 test procedure.

A sample of about 12.5 g of the sieved proppants was loaded into the test cell, constantly moving the test cell until a leveled surface of proppants was obtained. A Carver press with an upper piston and a lower piston was used to apply stress to the sample in the test cell. The pistons were inserted into the test cell and the press applied stress to the sample in the test cell. The stress was increased at a constant rate until the desired stress was achieved—either about 55.2 MPa (about 8,000 psi) or about 82.7 MPa (about 12,000 psi)—as specified. The sample was held at the desired stress for about 30 seconds, then the pressure was released. The crushed proppant was sieved with the second sieve (a #40 mesh sieve) and the amount of fines that passed through the second sieve was collected and weighed. The results for Examples 4-6 are provided in Table 1.

Embodiments of the present disclosure further relate to any one or more of the following paragraphs:

1. A plurality of proppants, comprising: a plurality of particles; and a cured composite resin, wherein: each of the particles is at least partially covered or completely covered by a continuous layer of the cured composite resin, the cured composite resin comprises a phenol-formaldehyde resin and an aluminosilicate clay, the aluminosilicate clay comprises a plurality of hollow tubular structures having an average exterior diameter of about 20 nm to about 200 nm and an average length of about 0.25 μm to about 10 μm, and the plurality of proppants has a dry crush strength of about 0.5 wt % to less than 10 wt % at a pressure of about 82.7 MPa.

2. A plurality of proppants, comprising: a plurality of particles; and a cured composite resin, wherein: each of the particles is at least partially covered or completely covered by a continuous layer of the cured composite resin, the cured composite resin comprises a phenol-formaldehyde resin and halloysite, the cured composite resin contains the halloysite in an amount of greater than 25 wt % to about 50 wt %, based on a solids weight of the phenol-formaldehyde resin, and the plurality of proppants has a dry crush strength of about 0.5 wt % to less than 10 wt % at a pressure of about 82.7 MPa.

3. A plurality of proppants, comprising: a plurality of particles comprising sand; and a cured composite resin, wherein: each of the particles is at least partially covered or completely covered by a continuous layer of the cured composite resin, the cured composite resin comprises a phenol-formaldehyde novolac resin and halloysite, the plurality of proppants has an average particle size of about 180 μm to about 2 mm, and the plurality of proppants has a dry crush strength of about 0.5 wt % to less than 10 wt % at a pressure of about 82.7 MPa.

4. A method for making a plurality of proppants, comprising: combining a phenol-formaldehyde resin and an aluminosilicate clay to produce a composite resin, wherein the aluminosilicate clay comprises a plurality of hollow tubular structures having an average exterior diameter of about 20 nm to about 200 nm and an average length of about 0.25 μm to about 10 μm; coating a plurality of particles with the composite resin and a cross-linker; and reacting the composite resin and the cross-linker to produce a plurality of proppants coated with a cured resin, wherein: each proppant comprises a particle of the plurality of particles at least partially covered or completely covered by a continuous layer of the cured resin, and the plurality of proppants has a dry crush strength of about 0.5 wt % to less than 10 wt % at a pressure of about 82.7 MPa.

5. A method for making a plurality of proppants, comprising: combining a phenol-formaldehyde novolac resin and a halloysite clay to produce a composite resin, wherein the halloysite clay is combined with the phenol-formaldehyde novolac resin in an amount of greater than 25 wt % to about 50 wt %, based on a solids weight of the phenol-formaldehyde novolac resin; coating a plurality of particles with the composite resin and a cross-linker; and reacting the composite resin and the cross-linker to produce a plurality of proppants coated with a cured resin, wherein: each proppant comprises a particle of the plurality of particles at least partially covered or completely covered by a continuous layer of the cured resin, and the plurality of proppants has a dry crush strength of about 0.5 wt % to less than 10 wt % at a pressure of about 82.7 MPa

6. The method according to paragraph 4 or 5, wherein combining the phenol-formaldehyde resin and the aluminosilicate clay to produce the composite resin further comprises: heating the phenol-formaldehyde resin having a solid state to produce a molten phenol-formaldehyde resin; adding the aluminosilicate clay to the molten phenol-formaldehyde resin to produce a mixture; and agitating the mixture to produce a dispersion comprising the molten phenol-formaldehyde resin and the aluminosilicate clay.

7. The method according to paragraph 6, wherein the phenol-formaldehyde resin having the solid state is heated to a temperature of about 50° C. to about 300° C. to produce the molten phenol-formaldehyde resin.

8. The method according to paragraph 6, further comprising cooling the dispersion to produce the composite resin having a solid state.

9. The method according to any one of paragraphs 4-8, wherein producing the plurality of proppants comprising the cured resin further comprises: heating the plurality of particles to a temperature of about 100° C. to about 400° C. to produce heated particles; adding the composite resin to the heated particles to produce a first mixture; agitating the first mixture to produce a plurality of coated particles comprising uncured resin; adding the cross-linker to the plurality of coated particles to produce a second mixture; and heating the second mixture to produce the plurality of proppants comprising the cured resin.

10. The method according to paragraph 9, further comprising adding a wax along with the cross-linker to the plurality of coated particles to produce the second mixture.

11. The method according to any one of paragraphs 4-10, wherein the cross-linker comprises hexamethylenetetramine.

12. The method according to any one of paragraphs 4-11, wherein the cross-linker is combined with the composite resin and the plurality of particles in an amount of about 0.05 wt % to about 3 wt %, based on a dry weight of the plurality of particles.

13. The proppants or method according to any one of paragraphs 1-12, wherein the cured composite resin contains the aluminosilicate clay in an amount of greater than 25 wt % to about 70 wt %, based on a solids weight of the phenol-formaldehyde resin.

14. The proppants or method according to any one of paragraphs 1-13, wherein the aluminosilicate clay comprises halloysite, and wherein the cured composite resin contains the aluminosilicate clay in an amount of greater than 25 wt % to about 50 wt %, based on a solids weight of the phenol-formaldehyde resin.

15. The proppants or method according to any one of paragraphs 1-14, wherein the aluminosilicate clay comprises greater than 85 wt % to about 99.99 wt % of halloysite.

16. The proppants or method according to any one of paragraphs 1-15, wherein the aluminosilicate clay comprises about 0.01 wt % to less than 5 wt % of impurities.

17. The proppants or method according to any one of paragraphs 1-16, wherein the aluminosilicate clay comprises greater than 85 wt % to about 99.99 wt % of halloysite and about 0.01 wt % to less than 5 wt % of quartz or silicon dioxide.

18. The proppants or method according to any one of paragraphs 1-17, wherein the aluminosilicate clay comprises halloysite, wherein at least a portion of the halloysite comprises a chemically treated surface.

19. The proppants or method according to paragraph 18, wherein the chemically treated surface comprises a reaction product of the clay and one or more reducing agents, one or more oxidizing agents, or one or more capping agents.

20. The proppants or method according to any one of paragraphs 1-19, wherein the aluminosilicate clay comprises halloysite, and wherein the halloysite comprises greater than 98.5 wt % to about 99.999 wt % of aluminosilicate.

21. The proppants or method according to any one of paragraphs 1-20, wherein the aluminosilicate clay comprises halloysite, and wherein at least a portion of the halloysite comprises a chemically treated surface or the halloysite comprises greater than 98.5 wt % to about 99.999 wt % of aluminosilicate.

22. The proppants or method according to any one of paragraphs 1-21, wherein the plurality of proppants has a dry crush strength of about 0.1 wt % to about 5 wt % at a pressure of about 55.2 MPa.

23. The proppants or method according to any one of paragraphs 1-22, wherein the plurality of proppants has an average particle size of about 180 μm to about 2 mm.

24. The proppants or method according to any one of paragraphs 1-23, wherein the plurality of proppants comprises the cured composite resin in an amount of about 0.5 wt % to about 10 wt %, based on a dry weight of the plurality of particles.

25. The proppants or method according to any one of paragraphs 1-24, wherein the cured composite resin comprises a reaction product of the composite resin, prior to being cured, and a cross-linker.

26. The proppants or method according to any one of paragraphs 1-25, wherein the cross-linker comprises hexamethylenetetramine.

27. The proppants or method according to any one of paragraphs 1-26, wherein the composite resin, prior to being cured, has a viscosity of about 1,000 cP to about 3,000 cP at a temperature of about 150° C.

28. The proppants or method according to any one of paragraphs 1-27, wherein the plurality of particles comprises sand, and wherein the phenol-formaldehyde resin comprises a phenol-formaldehyde novolac resin.

29. The proppants or method according to any one of paragraphs 1-28, wherein the plurality of proppants has a dry crush strength of about 0.1 wt % to about 5 wt % at a pressure of about 55.2 MPa.

30. The proppants or method according to any one of paragraphs 1-29, wherein the plurality of proppants has an average particle size of about 180 μm to about 2 mm.

31. The proppants or method according to any one of paragraphs 1-30, wherein the plurality of proppants comprises the cured composite resin in an amount of about 0.5 wt % to about 10 wt %, based on a dry weight of the plurality of particles.

32. The proppants or method according to any one of paragraphs 1-31, wherein the composite resin, prior to being cured, has a viscosity of about 1,000 cP to about 3,000 cP at a temperature of about 150° C.

33. The proppants or method according to any one of paragraphs 1-32, wherein the plurality of particles comprises sand, and wherein the phenol-formaldehyde resin comprises a phenol-formaldehyde novolac resin.

34. The proppants or method according to any one of paragraphs 1-33, wherein the plurality of particles comprises sand, and wherein the halloysite comprises a plurality of hollow tubular structures having an average exterior diameter of about 20 nm to about 200 nm and an average length of about 0.25 μm to about 10 μm.

35. The proppants or method according to any one of paragraphs 1-34, wherein the plurality of particles comprises sand, wherein the phenol-formaldehyde resin comprises a phenol-formaldehyde novolac resin, and wherein the halloysite comprises a plurality of hollow tubular structures having an average exterior diameter of about 20 nm to about 200 nm and an average length of about 0.25 μm to about 10 μm.

36. The proppants or method according to any one of paragraphs 1-35, wherein: the halloysite comprises a plurality of hollow tubular structures having an average exterior diameter of about 20 nm to about 200 nm and an average length of about 0.25 μm to about 10 μm, the cured composite resin comprises greater than 25 wt % to about 70 wt % of the halloysite, based on a solids weight of the phenol-formaldehyde novolac resin, and the plurality of proppants has a dry crush strength of about 0.1 wt % to about 5 wt % at a pressure of about 55.2 MPa.

37. A plurality of proppants, comprising: a plurality of particles; and a cured composite resin disposed on each particle of the plurality of particles, wherein: the cured composite resin, prior to being cured, comprises a phenol-formaldehyde resin and an aluminosilicate clay, the aluminosilicate clay comprises a plurality of hollow tubular structures having an average exterior diameter of about 20 nm to about 200 nm and an average length of about 0.25 μm to about 10 μm.

38. The proppants according to paragraph 37, wherein the plurality of proppants has a dry crush strength of about 0.5 wt % to less than 10 wt % at a pressure of about 82.7 MPa.

39. The proppants according to paragraph 37 or 38, wherein the plurality of proppants has a dry crush strength of about 0.1 wt % to about 5 wt % at a pressure of about 55.2 MPa.

40. The proppants according to any one of paragraphs 37 to 39, wherein the cured composite resin, prior to being cured, contains the aluminosilicate clay in an amount of greater than 25 wt % to about 70 wt %, based on a solids weight of the phenol-formaldehyde resin.

41. The proppants according to any one of paragraphs 37 to 40, wherein the aluminosilicate clay comprises halloysite, and wherein the cured composite resin, prior to being cured, contains the aluminosilicate clay in an amount of greater than 25 wt % to about 50 wt %, based on a solids weight of the phenol-formaldehyde resin.

42. The proppants according to any one of paragraphs 37 to 41, wherein the aluminosilicate clay comprises greater than 85 wt % to about 99.99 wt % of halloysite and about 0.01 wt % to less than 5 wt % of silicon dioxide.

43. The proppants according to any one of paragraphs 37 to 42, wherein the aluminosilicate clay comprises halloysite, and wherein at least a portion of the halloysite comprises a chemically treated surface or the halloysite comprises greater than 98.5 wt % to about 99.999 wt % of aluminosilicate.

44. The proppants according to any one of paragraphs 37 to 43, wherein the plurality of proppants has an average particle size of about 180 μm to about 2 mm.

45. The proppants according to any one of paragraphs 37 to 44, wherein the plurality of proppants comprises the cured composite resin in an amount of about 0.5 wt % to about 10 wt %, based on a dry weight of the plurality of particles.

46. The proppants according to any one of paragraphs 37 to 45, wherein the cured composite resin, prior to being cured, further comprises a cross-linker.

47. The proppants according to paragraph 46, wherein the cross-linker comprises hexamethylenetetramine.

48. The proppants according to paragraph 46 or 47, wherein the plurality of particles comprises sand, and wherein the phenol-formaldehyde resin comprises a phenol-formaldehyde novolac resin.

49. The proppants according to any one of paragraphs 37 to 48, wherein the composite resin, prior to being cured, has a viscosity of about 1,000 cP to about 3,000 cP at a temperature of about 150° C.

50. A plurality of proppants, comprising: a plurality of particles; and a cured composite resin disposed on each particle of the plurality of particles, wherein: the cured composite resin, prior to being cured, comprises a phenol-formaldehyde resin and halloysite, the cured composite resin, prior to being cured, comprises the halloysite in an amount of greater than 25 wt % to about 70 wt %, based on a solids weight of the phenol-formaldehyde resin, and the plurality of proppants has a dry crush strength of about 0.5 wt % to less than 10 wt % at a pressure of about 82.7 MPa.

51. The proppants according to paragraph 50, wherein the plurality of proppants has a dry crush strength of about 0.1 wt % to about 5 wt % at a pressure of about 55.2 MPa.

52. The proppants according to paragraph 50 or 51, wherein the plurality of proppants has an average particle size of about 180 μm to about 2 mm.

53. The proppants according to any one of paragraphs 50 to 52, wherein the plurality of proppants comprises the cured composite resin in an amount of about 0.5 wt % to about 10 wt %, based on a dry weight of the plurality of particles.

54. The proppants according to any one of paragraphs 50 to 53, wherein: the cured composite resin, prior to being cured, further comprises hexamethylenetetramine.

55. The proppants according to any one of paragraphs 50 to 54, wherein the composite resin, prior to being cured, has a viscosity of about 1,000 cP to about 3,000 cP at a temperature of about 150° C.

56. The proppants according to any one of paragraphs 50 to 55, wherein the plurality of particles comprises sand, the phenol-formaldehyde resin comprises a phenol-formaldehyde novolac resin, and the halloysite comprises a plurality of hollow tubular structures having an average exterior diameter of about 20 nm to about 200 nm and an average length of about 0.25 μm to about 10 μm.

57. A plurality of proppants, comprising: a plurality of particles comprising sand; and a cured composite resin disposed on each particle of the plurality of particles, wherein: each particle of the plurality of particles is completely covered by a continuous layer of the cured composite resin, the cured composite resin, prior to being cured, comprises a phenol-formaldehyde novolac resin, halloysite, and a cross-linker, the plurality of proppants has an average particle size of about 180 μm to about 2 mm, and the plurality of proppants has a dry crush strength of about 0.5 wt % to less than 10 wt % at a pressure of about 82.7 MPa.

58. The proppants according to paragraph 57, wherein: the halloysite comprises a plurality of hollow tubular structures having an average exterior diameter of about 20 nm to about 200 nm and an average length of about 0.25 μm to about 10 μm, the cross-linker comprises hexamethylenetetramine, the cured composite resin, prior to being cured, comprises greater than 25 wt % to about 70 wt % of the halloysite, based on a solids weight of the phenol-formaldehyde novolac resin, and the plurality of proppants has a dry crush strength of about 0.1 wt % to about 5 wt % at a pressure of about 55.2 MPa.

59. The proppants according to any one of paragraphs 36 to 58, wherein each of the particles of the plurality of particles is at least partially covered or completely covered by a continuous layer of the cured composite resin.

60. The proppants according to any one of paragraphs 1-36 and 38 to 59, wherein the dry crush strength is measured according to the Proppant Crush Resistance Test Procedure under ISO 13503-2:2011, modified as follows: the cell comprises a stainless steel cylinder having a length of about 7.63 cm and a bore formed therethrough, a removable bottom piston that extends about 1.30 cm into the bore from a bottom of the cylinder, and a removable upper piston having a length of about 7.75 cm that extends into the bore from a top of the cylinder, wherein the diameter of each piston is about 2.87 cm, wherein a weight of the plurality of proppants introduced to the cylinder is about 12.6 grams, wherein the pressure is manually applied, and wherein the applied pressure is held for about 30 seconds.

61. A plurality of proppants, comprising: a plurality of particles; and a curable composite resin disposed on each particle of the plurality of particles, wherein: the curable composite resin comprises a phenol-formaldehyde resin and an aluminosilicate clay, and the aluminosilicate clay comprises a plurality of hollow tubular structures having an average exterior diameter of about 20 nm to about 200 nm and an average length of about 0.25 μm to about 10 μm.

62. The proppants according to paragraph 61, wherein the curable composite resin contains the aluminosilicate clay in an amount of greater than 25 wt % to about 70 wt %, based on a solids weight of the phenol-formaldehyde resin.

63. The proppants according to paragraph 61 or 62, wherein the aluminosilicate clay comprises halloysite, and wherein the curable composite resin contains the aluminosilicate clay in an amount of greater than 25 wt % to about 50 wt %, based on a solids weight of the phenol-formaldehyde resin.

64. The proppants according to any one of paragraphs 61 to 63, wherein the aluminosilicate clay comprises greater than 85 wt % to about 99.99 wt % of halloysite and about 0.01 wt % to less than 5 wt % of silicon dioxide.

65. The proppants according to any one of paragraphs 61 to 63, wherein the aluminosilicate clay comprises halloysite, and wherein at least a portion of the halloysite comprises a chemically treated surface or the halloysite comprises greater than 98.5 wt % to about 99.999 wt % of aluminosilicate.

66. The proppants according to any one of paragraphs 61 to 65, wherein the plurality of proppants has an average particle size of about 180 μm to about 2 mm.

67. The proppants according to any one of paragraphs 61 to 66, wherein the plurality of proppants comprises the curable composite resin in an amount of about 0.5 wt % to about 10 wt %, based on a dry weight of the plurality of particles.

68. The proppants according to any one of paragraphs 61 to 67, wherein the curable composite resin further comprises a cross-linker.

69. The proppants according to paragraph 68, wherein the cross-linker comprises hexamethylenetetramine.

70. The proppants according to paragraph 68 or 69, wherein the plurality of particles comprises sand, and wherein the phenol-formaldehyde resin comprises a phenol-formaldehyde novolac resin.

71. The proppants according to any one of paragraphs 61 to 70, wherein the curable composite resin has a viscosity of about 1,000 cP to about 3,000 cP at a temperature of about 150° C.

72. A plurality of proppants, comprising: a plurality of particles; and a curable composite resin disposed on each particle of the plurality of particles, wherein: the curable composite resin comprises a phenol-formaldehyde resin and halloysite, the curable composite resin contains the halloysite in an amount of greater than 25 wt % to about 70 wt %, based on a solids weight of the phenol-formaldehyde resin.

73. The proppants according to paragraph 72 or 73, wherein the plurality of proppants has an average particle size of about 180 μm to about 2 mm.

74. The proppants according to any one of paragraphs 72 to 74, wherein the plurality of proppants comprises the curable composite resin in an amount of about 0.5 wt % to about 10 wt %, based on a dry weight of the plurality of particles.

75. The proppants according to any one of paragraphs 72 to 75, wherein: the curable composite resin further comprises a cross-linker, the plurality of particles comprises sand, the phenol-formaldehyde resin comprises a phenol-formaldehyde novolac resin, the halloysite comprises a plurality of hollow tubular structures having an average exterior diameter of about 20 nm to about 200 nm and an average length of about 0.25 μm to about 10 μm, and the curable composite resin has a viscosity of about 1,000 cP to about 3,000 cP at a temperature of about 150° C.

76. A plurality of proppants, comprising: a plurality of particles comprising sand; and a curable composite resin disposed on each particle of the plurality of particles, wherein: each particle of the plurality of particles is completely covered by a continuous layer of the curable composite resin, the curable composite resin comprises a phenol-formaldehyde novolac resin and halloysite, and the plurality of proppants has an average particle size of about 180 μm to about 2 mm.

77. The proppants according to paragraph 77, wherein: the halloysite comprises a plurality of hollow tubular structures having an average exterior diameter of about 20 nm to about 200 nm and an average length of about 0.25 μm to about 10 μm, the cured composite resin, prior to being cured, comprises greater than 25 wt % to about 70 wt % of the halloysite, based on a solids weight of the phenol-formaldehyde novolac resin.

78. The proppants according to any one of paragraphs 61 to 78, wherein each of the particles of the plurality of particles is at least partially covered or completely covered by a continuous layer of the curable composite resin.

79. A proppant, comprising: a particle; and a cured composite resin disposed on the particle, wherein the cured composite resin, prior to being cured, comprises a phenol-formaldehyde resin and an aluminosilicate clay, and wherein the aluminosilicate clay comprises a plurality of hollow tubular structures having an average exterior diameter of about 20 nm to about 200 nm and an average length of about 0.25 μm to about 10 μm.

80. The proppant according to paragraph 79, wherein the particle comprises frac sand, silica sand, glass, quartz, silicon dioxide, silica, silicates, other silicon oxide sources, or any mixture thereof.

81. The proppant according to paragraph 79 or 80, wherein the aluminosilicate clay comprises halloysite.

82. The proppant according to any one of paragraphs 79 to 81, wherein the cured composite resin, prior to being cured, contains the aluminosilicate clay in an amount of greater than 25 wt % to about 50 wt %, based on a solids weight of the phenol-formaldehyde resin.

83. The proppant according to any one of paragraphs 79 to 82, wherein the composite resin, prior to being cured, has a viscosity of about 1,000 cP to about 3,000 cP at a temperature of about 150° C.

84. The proppant according to any one of paragraphs 79 to 83, wherein the phenol-formaldehyde resin comprises a phenol-formaldehyde novolac resin, and wherein the cured composite resin, prior to being cured, further comprises hexamethylenetetramine.

85. The proppant according to any one of paragraphs 79 to 84, wherein the aluminosilicate clay comprises greater than 85 wt % to about 99.99 wt % of halloysite and about 0.01 wt % to less than 5 wt % of silicon dioxide.

86. The proppant according to any one of paragraphs 79 to 85, wherein the aluminosilicate clay comprises halloysite, and wherein at least a portion of the halloysite comprises a chemically treated surface or the halloysite comprises greater than 98.5 wt % to about 99.999 wt % of aluminosilicate.

87. The proppant according to any one of paragraphs 79 to 86, wherein the particle is at least partially covered or completely covered by a continuous layer of the cured composite resin.

88. The proppants or proppant according to any one of paragraphs 61 to 87, wherein the plurality of proppants or proppant has a dry crush strength of about 0.5 wt % to less than 10 wt % at a pressure of about 82.7 MPa when the curable composite resin is cured.

89. The proppants or proppant according to any one of paragraphs 61 to 88, wherein the plurality of proppants or proppant has a dry crush strength of about 0.1 wt % to about 5 wt % at a pressure of about 55.2 MPa when the curable composite resin is cured.

90. The proppants or proppant according to paragraph 87 or 89, wherein the dry crush strength is measured according to the Proppant Crush Resistance Test Procedure under ISO 13503-2:2011, modified as follows: the cell comprises a stainless steel cylinder having a length of about 7.63 cm and a bore formed therethrough, a removable bottom piston that extends about 1.30 cm into the bore from a bottom of the cylinder, and a removable upper piston having a length of about 7.75 cm that extends into the bore from a top of the cylinder, wherein the diameter of each piston is about 2.87 cm, wherein a weight of the plurality of proppants introduced to the cylinder is about 12.6 grams, wherein the pressure is manually applied, and wherein the applied pressure is held for about 30 seconds.

91. The proppants according to any one of paragraphs 1 to 59 and 61 to 89, wherein the dry crush strength is measured according to the Proppant Crush Resistance Test Procedure under ISO 13503-2:2011.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A plurality of proppants, comprising:
a plurality of particles; and
a cured composite resin disposed on each particle of the plurality of particles, wherein the cured composite resin, prior to being cured, comprises a phenol-formaldehyde resin and an aluminosilicate clay, and wherein the aluminosilicate clay comprises a plurality of hollow tubular structures having an average exterior diameter of about 20 nm to about 200 nm and an average length of about 0.25 μm to about 10 μm.

2. The proppants of claim 1, wherein the plurality of proppants has a dry crush strength of about 0.5 wt % to less than 10 wt % at a pressure of about 82.7 MPa.

3. The proppants of claim 1, wherein the plurality of proppants has a dry crush strength of about 0.1 wt % to about 5 wt % at a pressure of about 55.2 MPa.

4. The proppants of claim 1, wherein the cured composite resin, prior to being cured, contains the aluminosilicate clay in an amount of greater than 25 wt % to about 70 wt %, based on a solids weight of the phenol-formaldehyde resin.

5. The proppants of claim 1, wherein the aluminosilicate clay comprises halloysite, and wherein the cured composite resin, prior to being cured, contains the aluminosilicate clay in an amount of greater than 25 wt % to about 50 wt %, based on a solids weight of the phenol-formaldehyde resin.

6. The proppants of claim 1, wherein the aluminosilicate clay comprises greater than 85 wt % to about 99.99 wt % of halloysite and about 0.01 wt % to less than 5 wt % of silicon dioxide.

7. The proppants of claim 1, wherein the aluminosilicate clay comprises halloysite, and wherein at least a portion of the halloysite comprises a chemically treated surface or the halloysite comprises greater than 98.5 wt % to about 99.999 wt % of aluminosilicate.

8. The proppants of claim 1, wherein the plurality of proppants has an average particle size of about 180 μm to about 2 mm.

9. The proppants of claim 1, wherein the plurality of proppants comprises the cured composite resin in an amount of about 0.5 wt % to about 10 wt %, based on a dry weight of the plurality of particles.

10. The proppants of claim 1, wherein the cured composite resin, prior to being cured, further comprises a cross-linker.

11. The proppants of claim 10, wherein the cross-linker comprises hexamethylenetetramine.

12. The proppants of claim 10, wherein the plurality of particles comprises sand, and wherein the phenol-formaldehyde resin comprises a phenol-formaldehyde novolac resin.

13. The proppants of claim 1, wherein the composite resin, prior to being cured, has a viscosity of about 1,000 cP to about 3,000 cP at a temperature of about 150° C.

14. A plurality of proppants, comprising:
a plurality of particles; and
a cured composite resin disposed on each particle of the plurality of particles, wherein:
the cured composite resin, prior to being cured, comprises a phenol-formaldehyde resin and halloysite,
the cured composite resin, prior to being cured, comprises the halloysite in an amount of greater than 25 wt % to about 70 wt %, based on a solids weight of the phenol-formaldehyde resin, and
the plurality of proppants has a dry crush strength of about 0.5 wt % to less than 10 wt % at a pressure of about 82.7 MPa.

15. The proppants of claim 14, wherein the plurality of proppants has a dry crush strength of about 0.1 wt % to about 5 wt % at a pressure of about 55.2 MPa.

16. The proppants of claim 14, wherein the plurality of proppants has an average particle size of about 180 μm to about 2 mm.

17. The proppants of claim 14, wherein the plurality of proppants comprises the cured composite resin in an amount of about 0.5 wt % to about 10 wt %, based on a dry weight of the plurality of particles.

18. The proppants of claim 14, wherein:
the cured composite resin, prior to being cured, further comprises hexamethylenetetramine,
the plurality of particles comprises sand,
the phenol-formaldehyde resin comprises a phenol-formaldehyde novolac resin,
the halloysite comprises a plurality of hollow tubular structures having an average exterior diameter of about 20 nm to about 200 nm and an average length of about 0.25 μm to about 10 μm, and
the composite resin, prior to being cured, has a viscosity of about 1,000 cP to about 3,000 cP at a temperature of about 150° C.

19. A plurality of proppants, comprising:
a plurality of particles comprising sand; and
a cured composite resin disposed on each particle of the plurality of particles, wherein:
each particle of the plurality of particles is completely covered by a continuous layer of the cured composite resin,
the cured composite resin, prior to being cured, comprises a phenol-formaldehyde novolac resin, halloysite, and a cross-linker,
the plurality of proppants has an average particle size of about 180 μm to about 2 mm, and
the plurality of proppants has a dry crush strength of about 0.5 wt % to less than 10 wt % at a pressure of about 82.7 MPa.

20. The proppants of claim 19, wherein:
the halloysite comprises a plurality of hollow tubular structures having an average exterior diameter of about 20 nm to about 200 nm and an average length of about 0.25 μm to about 10 μm,
the cross-linker comprises hexamethylenetetramine,
the cured composite resin, prior to being cured, comprises greater than 25 wt % to about 70 wt % of the halloysite, based on a solids weight of the phenol-formaldehyde novolac resin, and
the plurality of proppants has a dry crush strength of about 0.1 wt % to about 5 wt % at a pressure of about 55.2 MPa.
